(19) United States
(12) Patent Application Publication
(10) Pub. No.: US 2022/0001454 A1
(43) Pub. Date: Jan. 6, 2022

(54) On-vehicle disk brake lathe system with capture device and use thereof

(71) Applicant: Snap-on Incorporated, Kenosha, WI (US)

(72) Inventors: Christopher L. Greenwald, Waban, MA (US); Jeffrey P. Hastings, Hanover, NH (US); Roy S. Brozovich, Campbell, CA (US)

(21) Appl. No.: 16/918,953

(22) Filed: Jul. 1, 2020

(51) Int. Cl. B23B 5/04

(52) U.S. Cl. CPC B23B 5/04; B23B 2235/04

(57) ABSTRACT

An on-vehicle disk brake lathe system is attachable to a vehicle in order to machine a brake disk attached to a wheel hub and rotating about a wheel hub axis. The brake disk has an in-board friction face and an out-board friction face opposite the in-board friction face. The on-vehicle disk brake lathe system comprises a cutting mechanism and a brake disk drive unit including a wheel hub adaptor removably connectable to the wheel hub and a motor configured to rotate the wheel hub adaptor and the brake disk when the wheel hub adaptor is connected to the wheel hub. Further, the on-vehicle disk brake lathe system comprises a capture device. The capture device is configured to be moved to a position at which the capture device can capture an image showing at least a portion of the brake disk and/or at least a portion of the cutting mechanism.

### BACKGROUND

Many vehicles are equipped with a brake system to slow or stop the vehicles. Some vehicles with a brake system, such as automobiles, include disk brakes, drum brakes, or disk and drum brakes. Among other things, a disk brake includes a rotatable metal brake disk, a brake caliper, and brake shoes attached to the brake caliper and configured to contact an inboard or outboard friction face of the brake disk. Applying the vehicle brakes by pressing a brake pedal causes the brake caliper to squeeze the brake shoes against the inboard and outboard friction faces of the brake disk. A drum brake includes a rotatable metal brake drum, a brake cylinder, a pair of brake pistons, and a pair of brake shoes configured to contact an interior surface of the brake drum. Applying the vehicle brakes by pressing the brake pedal causes the brake cylinder to move the brake pistons outward from the brake cylinder. Movement of the brake pistons causes the pair of brake shoes to contact the brake drum.

Applying the brakes of a brake system causes the brake shoes, brake disks, and brake drums to wear. Unfortunately, those brake components typically do not wear evenly. Unevenly worn brake components can cause vibrations to be felt throughout the vehicle. Fortunately, brake shoes, brake disks, and brake drums can be replaced. Moreover, brake disks and brake drums can be machined to extend the life of the brake disks and brake drums before the brake disks and brake drums need to be replaced.

Early on, technician removed brake disks and brake drums from a vehicle and machined the brake disks and brake drums using a lathe while the brake disks and brake drums were removed from the vehicle. More recently, technicians have machined brake disks using an on-vehicle disk brake lathe. The use of on-vehicle disk brake lathe has gained popularity especially as vehicle manufacturers began manufacturing more vehicles using disk brakes exclusively (i.e., without drum brakes).

### OVERVIEW

In a first implementation, an on-vehicle disk brake lathe system is provided. The on-vehicle disk brake lathe system is attachable to a vehicle in order to machine a brake disk while the brake disk remains attached to a wheel hub and rotates about a wheel hub axis. The brake disk has an in-board friction face and an out-board friction face opposite the in-board friction face. The on-vehicle disk brake lathe system comprises a cutting mechanism. The on-vehicle disk brake lathe system also comprises a brake disk drive unit including a wheel hub adaptor removably connectable to the wheel hub and a motor configured to rotate the wheel hub adaptor and the brake disk when the wheel hub adaptor is connected to the wheel hub. The on-vehicle disk brake lathe system further comprises a capture device. The capture device is configured to be moved to a position at which the capture device can capture an image showing one or more from among: at least a portion of the brake disk or at least a portion of the cutting mechanism.

In a second implementation, an on-vehicle disk brake lathe system is provided. The on-vehicle disk brake lathe system is attachable to a vehicle in order to machine a brake disk while the brake disk remains attached to a wheel hub and rotates about a wheel hub axis. The brake disk has an in-board friction face and an out-board friction face opposite the in-board friction face. The on-vehicle disk brake lathe system comprises a motor and a brake disk drive unit. The brake disk drive unit includes a motor connection configured to be driven by the motor and a wheel hub adaptor operatively connectable to the motor connection and removably connectable to the wheel hub. The motor connection is further configured to rotate the wheel hub adaptor and the brake disk when the wheel hub adaptor is connected to the wheel hub. The on-vehicle disk brake lathe system further includes a cutting mechanism. The cutting mechanism includes a pair of cutting tools including a first cutting tool having a first cutting tip and a second cutting tool having a second cutting tip. The cutting mechanism further includes a lathe body connected to the pair of cutting tools. The first cutting tool is configured to be positioned with the first cutting tip contacting the in-board friction face and the second cutting tool is configured to be positioned with the second cutting tip contacting the out-board friction face. The cutting mechanism further includes a feed mechanism that is configured to direct the first cutting tool across the in-board friction face along a first feed path as the brake disk rotates and to direct the second cutting tool across the out-board friction face along a second feed path as the brake disk rotates. The feed mechanism is operatively connectable to the motor. The on-vehicle disk brake lathe system further comprises a capture device, wherein the capture device is configured to be moved to a position at which the capture device can capture an image showing one or more from among: at least a portion of the brake disk or at least a portion of the cutting mechanism.

Other implementations will become apparent to those of ordinary skill in the art by reading the following detailed description, with reference where appropriate to the accompanying drawings.

### BRIEF DESCRIPTION OF THE DRAWINGS

Example implementations are described herein with reference to the drawings.

FIG. 1 shows a vehicle on a vehicle lift in accordance with the example implementations.

FIG. 2 is a block diagram of an on-vehicle disk brake lathe system in accordance with the example implementations.

FIG. 3 is an isometric view of an on-vehicle disk brake lathe system and vehicle aspects of a vehicle in accordance with at least some of the example implementations

FIG. 4 shows details of a cutting mechanism including the cutting tools and the capture device of the implementation shown in FIG. 3.

FIG. 5 shows details of a cutting mechanism including the cutting tools of the implementations shown in FIG. 3 and a capture device in accordance with at least some example implementations.

FIG. 6 is a block diagram of an on-vehicle disk brake lathe system in accordance with the example implementations.

FIG. 7 is a block diagram representing memory of the on-vehicle disk brake lathe system shown in FIG. 6 in accordance with the example implementations.

FIG. 8 shows a capture device in accordance with the example implementations.

FIG. 9 and FIG. 10 are isometric views of an on-vehicle disk brake lathe system in accordance with at least some of the example implementations.

FIG. 11 and FIG. 12 are side views of the on-vehicle disk brake lathe system shown in FIG. 9 and FIG. 10.

FIG. 13 is a top view of the on-vehicle disk brake lathe system shown in FIG. 9 and FIG. 10.

FIG. 14 and FIG. 15 are close up isometric views of the on-vehicle disk brake lathe system shown in FIG. 9 and FIG. 10.

FIG. 16, FIG. 17, and FIG. 18 are exploded view diagrams showing details of the on-vehicle disk brake lathe system shown in FIG. 9 to FIG. 15.

FIG. 19 is an isometric view of a portion of an on-vehicle disk brake lathe system in accordance with at least some of the example implementations.

FIG. 20 is a side view of the portion of the on-vehicle disk brake lathe system shown in

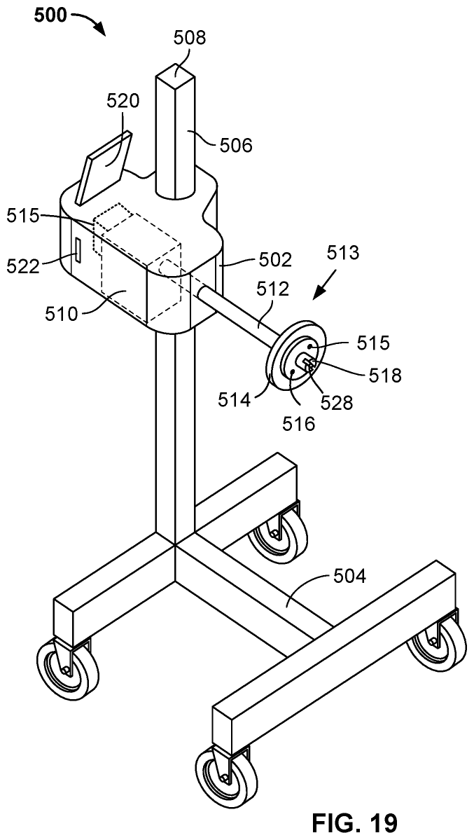

FIG. 19.

FIG. 21 shows a wheel hub adaptor in accordance with at least some of the example implementations.

FIG. 22 is a side view of another portion of the on-vehicle disk brake lathe system shown in FIG. 19.

FIG. 23 is a top view of the portion of the on-vehicle disk brake lathe system shown in FIG. 22.

FIG. 24 shows a portion of the on-vehicle disk brake lathe system shown in FIG. 19 attached to a vehicle on a vehicle lift.

FIG. 25 shows a caliper bracket mounting adaptor in accordance with at least some of the example implementations.

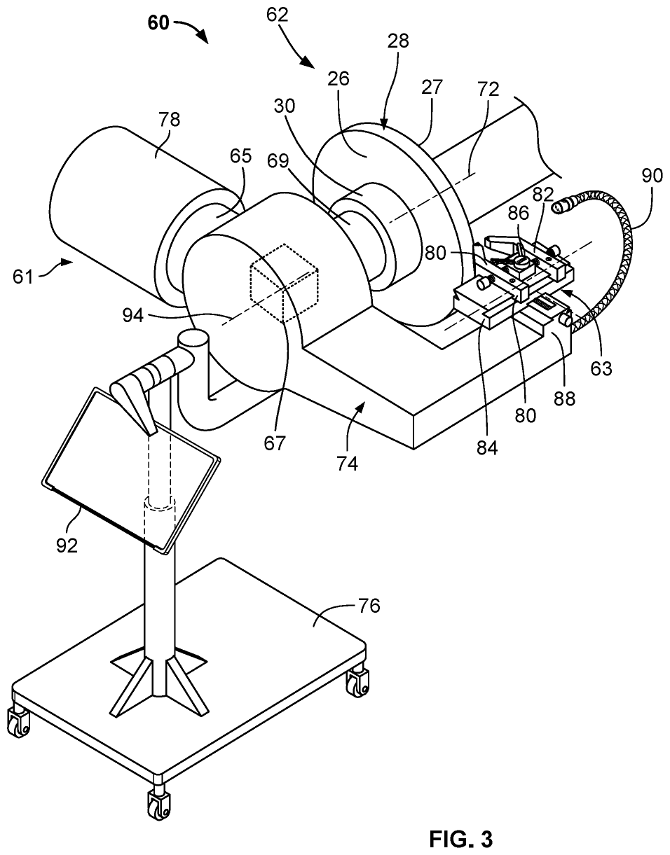

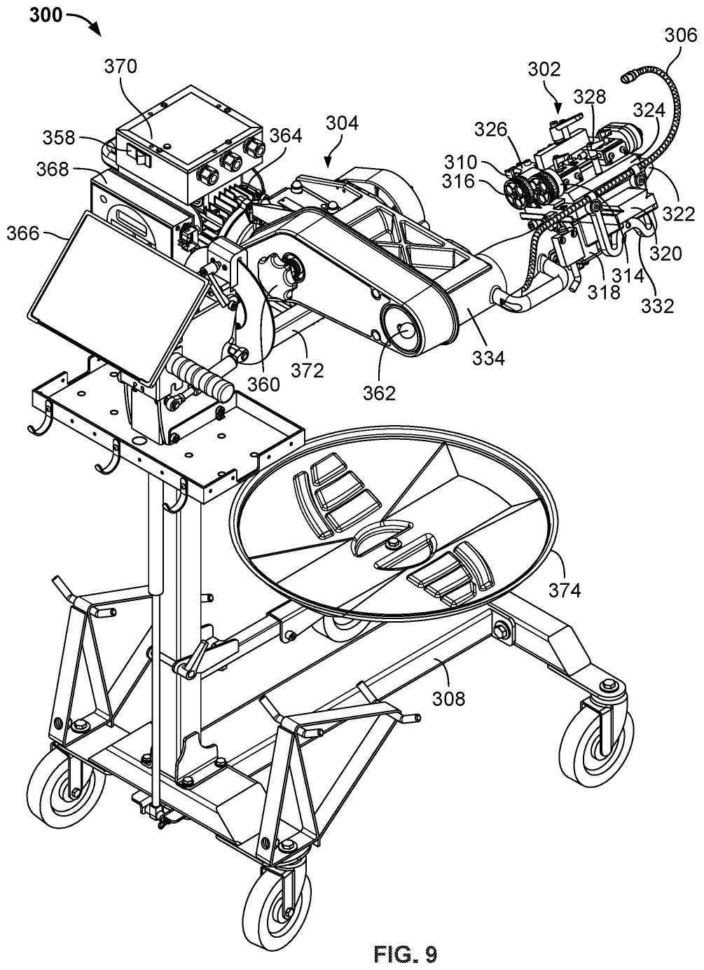

FIG. 26 shows wheel hub adaptors for use with the on-vehicle disk brake lathe system shown in FIG. 3, FIG. 9, and FIG. 19.

FIG. 27, FIG. 28, FIG. 29, FIG. 30, FIG. 31, and FIG. 32 show images captured by a capture device in accordance with the example implementations.

All the figures are schematic, not necessarily to scale, and generally show parts which are necessary to explain example implementations, wherein other parts may be omitted or merely suggested.

### DETAILED DESCRIPTION

### I. Introduction

This description describes several example implementations, at least some which pertain to an on-vehicle disk brake lathe system and/or use thereof. An on-vehicle disk brake lathe is configured to resurface a brake disk of a vehicle while the brake disk is attached to the vehicle. The on-vehicle disk brake lathe includes a brake disk drive unit and a cutting mechanism. In at least some implementations, the brake disk drive unit and the cutting mechanism are rigidly attached to each other as an integral on-vehicle disk brake lathe system. In at least some other implementations, the brake disk drive unit and the cutting mechanism are separate, distributed aspects of the on-vehicle disk brake lathe system.

In any of the aforementioned implementations, the on-vehicle disk brake lathe system can include a capture device. The capture device can capture an image of a brake disk attached to the vehicle and/or an image of the on-vehicle disk brake lathe while the on-vehicle disk brake lathe is attached to the vehicle. The brake disk can be stationary or rotating when the image is captured. Moreover, the image can be captured while the on-vehicle disk brake lathe is machining the brake disk.

The on-vehicle disk brake lathe can include a display configured to display an image captured by the capture device. In this way, for example, on-vehicle disk brake lathe can capture and display an image of an in-board friction face of a brake disk while the brake disk is rotating and being machined by the on-vehicle disk brake lathe such that a person can see a view of the in-board friction face of the brake disk without having to position their head within a wheel well of the vehicle 10 or otherwise in close proximity to the rotating brake disk.

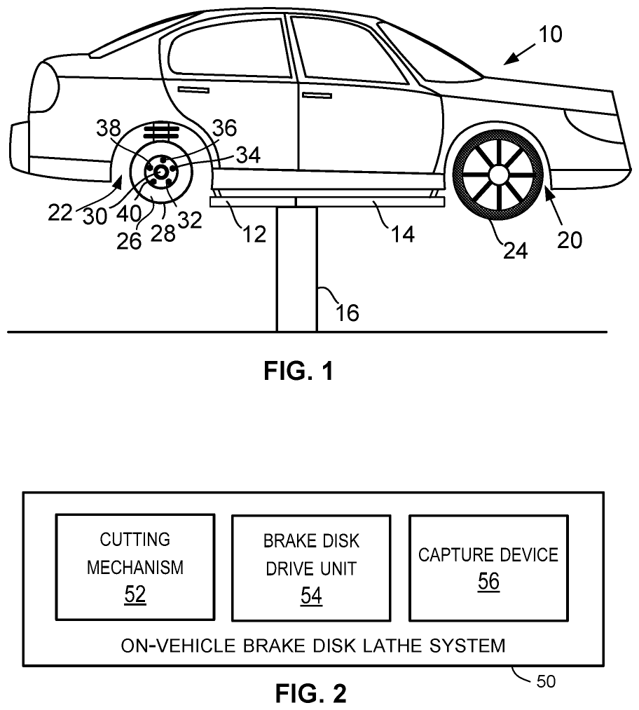

FIG. 1 shows a vehicle 10 positioned on lift arm 12, 14 of a single-post vehicle lift 16. The vehicle 10 includes a wheel well 20, 22, which is a recess in the vehicle 10 in which a wheel can be attached, such as a wheel 24 attached to the vehicle 10 within the wheel well 20. FIG. 1 shows the vehicle 10 without a wheel attached within the wheel well 22 such that a first disk surface 26 of a brake disk 28 is more readably visible to a person looking at a side of the vehicle 10 shown in FIG. 1. The brake disk 28 also includes a second disk surface (not shown in FIG. 1, but see the second disk surface 27 shown in FIG. 28) opposite the first disk surface 26. The first disk surface 26 can be referred to as an out-board disk surface and/or an out-board friction face. The second disk surface can be referred to an in-board disk surface and/or in-board friction face. The brake disk 28 is mounted on a wheel hub 30, which can include a number of wheel lugs. As shown in FIG. 1, the wheel hub 30 includes a wheel lug 32, 34, 36, 38, 40.

A wheel on a vehicle, such as the wheel 24, typically includes a tire. A tire includes a tire tread that extends between in-board and out-board sides walls of the tire. The wheel wells of most vehicles are designed to have a clearance that permits a wheel positioned within the wheel well to turn without any portion of the tire tread of that wheel contacting another portion of the vehicle. The clearance of a wheel well is typically not large enough to allow a person to easily see the in-board friction face of a brake disk while the brake disk is mounted on a wheel hub of the vehicle. Attaching a brake disk drive unit and/or a cutting mechanism to a vehicle makes it even more challenging to see the in-board friction face of a brake disk. Use of a capture device of on-vehicle disk brake lathe system to capture an image of the in-board friction face or another portion of a brake disk and to display the captured image can overcome the challenge of seeing the in-board friction face of a brake disk.

Although FIG. 1 shows the vehicle 10 in the form of an automobile, the on-vehicle disk brake lathe system implementations can be used on other types of vehicles as well. Other examples of vehicles are discussed in Section V of this description.

### II. On-Vehicle Disk Brake Lathe Systems and Components

A. Overview of On-Vehicle Disk Brake Lathe Systems

Next, FIG. 2 is a block diagram of an on-vehicle disk brake lathe system 50 in accordance with the example implementations. The on-vehicle disk brake lathe system 50 includes a cutting mechanism 52, a brake disk drive unit 54, and a capture device 56. The on-vehicle disk brake lathe system 50 is attachable to a vehicle, such as the vehicle 10, in order to machine (e.g., resurface) a brake disk, such as the brake disk 28, while the brake disk remains attached to a wheel hub, such as the wheel hub 30, and rotates about a wheel hub axis.

The cutting mechanism 52 is configured for resurfacing disk surfaces of a brake disk. In particular, the cutting mechanism 52 includes a first cutting tool for resurfacing a first disk surface 26 of the brake disk 28 and a second cutting tool for resurfacing a second disk surface 27 of the brake disk 28. The first and second cutting tools can include a respective, replaceable cutting tip configured to contact a friction face of a brake disk.

The brake disk drive unit 54 is configured for rotating a wheel hub and the brake disk about a lathe axis and a hub axis. Examples of a lathe axis and a hub axis are shown at least in FIG. 3. The brake disk drive unit 54 can include a wheel hub adaptor that is removably connectable to a wheel hub of a vehicle. The brake disk drive unit 54 can include one or more electric motors. An electrical motor of the brake disk drive unit 54 can rotate the wheel hub adaptor and the brake disk connected to the wheel hub adaptor.

In at least some implementations, the brake disk drive unit 54 includes means for advancing the cutting tools of the cutting mechanism 52 along feed paths normal to the lathe axis. In at least some of those implementations, the cutting mechanism 52 and the brake disk drive unit 44 are rigidly attached to each other.

In at least some other implementations, the cutting mechanism 52 includes means for advancing the cutting tools of the cutting mechanism 52 along feed paths normal to the lathe axis. In at least some of those implementations, the cutting mechanism 52 and the brake disk drive unit 54 are not rigidly attached to each other.

A capture device, such as the capture device 56 and/or any other capture device described in this description can include one or more capture devices. In one respect, the capture device 56 can include an infrared radiation capture device, a visible light radiation capture device, or an ultraviolet radiation capture device. Those capture devices can include an infrared sensor configured to detect infrared radiation, a visible light sensor configured to detect visible light radiation, or an ultraviolet light sensor configured to detect ultraviolet radiation, respectively. In another respect, the capture device 56 can include two or more capture devices. As an example, the capture device 56 can include two visible light radiation capture devices or a visible light radiation capture device and an infrared radiation capture device.

The infrared sensor can include and/or be arranged as an infrared sensor array. As an example, the infrared sensor can detect radiation having frequencies of about 3×10¹¹ to 4×10¹⁴ cycles per second, or hertz (Hz) and wavelengths of about 1 millimeter (mm) to 740 (nanometer) nm, or some portion of those ranges of frequency and wavelength. A capture device that includes an infrared sensor can include and/or be referred to as a thermal camera, a thermal imaging device, or an infrared camera.

The visible light sensor can include and/or be arranged as visible light sensor array. As an example, the visible light sensor can detect radiation having frequencies of about 4×10¹⁴ to 8×10¹⁴ cycles per second, or hertz (Hz) and wavelengths of about 740 nm to 380 nm, or some portion of those ranges of frequency and wavelength. A capture device that includes a visible light sensor can include and/or be referred to as a visible light camera.

The ultraviolet light sensor can include and/or be arranged as ultraviolet light sensor array. As an example, the ultraviolet light sensor can detect radiation having frequencies of about 8×10¹⁴ to 3×10¹⁶ cycles per second, or Hz and wavelengths of about 380 nanometers (nm) to 10 nm, or some portion of those ranges of frequency and wavelength. A capture device that includes an ultraviolet light sensor can include and/or be referred to as an ultraviolet light camera.

The capture device 56 can capture and output a still image. Additionally or alternatively, the capture device 56 can capture and output a stream of images. The still image and/or the stream of images can be displayed on a display, such as a display 178. Additionally or alternatively, the still image and/or the stream of images can be stored in a memory, such as a memory 172. Moreover, in at least some implementations, the still image and/or the stream of images can be analyzed by a processor, such as a processor 170 executing computer-readable program instructions.

In at least some implementations, the capture device 56 includes a borescope. In those or in other implementations, the capture device 56 can include an infrared sensor, a visible light sensor, or an ultraviolet sensor within a flexible conduit. Any borescope described in this description can include an infrared sensor, a visible light sensor, or an ultraviolet sensor.

The flexible conduit allows the capture device to be repositioned. In at least some implementations, the flexible conduit is sturdy such that the capture device remains steady while the on-vehicle disk brake lathe system 50 is machining a brake disk. As an example, the flexible conduit can include a hot-dipped zinc galvanized low carbon steel. Other example materials for the flexible conduit are also possible.

Moreover, a lens and/or light source can also be within the flexible conduit. Any lens described in this description can include a lens assembly configured to collect infrared radiation, visible light radiation, and/or ultraviolet radiation from within a field of view and focus that radiation on a focal plane of a corresponding sensor. As an example, a light source described in this description can include one or more light emitting diodes. As another example, a light source described in this description can include an incandescent bulb, such as an incandescent bulb containing a pressurized gas, such as xenon, halogen, or krypton. Other examples of the light source are also possible.

The image capture device 56 can be moved to a position at which the image capture device 56 can capture an image of at least a portion of the brake disk 28 to which the on-vehicle disk brake lathe system 50 is attached and/or at least a portion of the cutting mechanism 52. As an example, the portion of the brake disk 28 can include a portion of the first disk surface 26 and/or a portion of the second disk surface 27. As another example, the portion of the cutting mechanism 52 can include a portion of a cutting tool of the cutting mechanism 52.

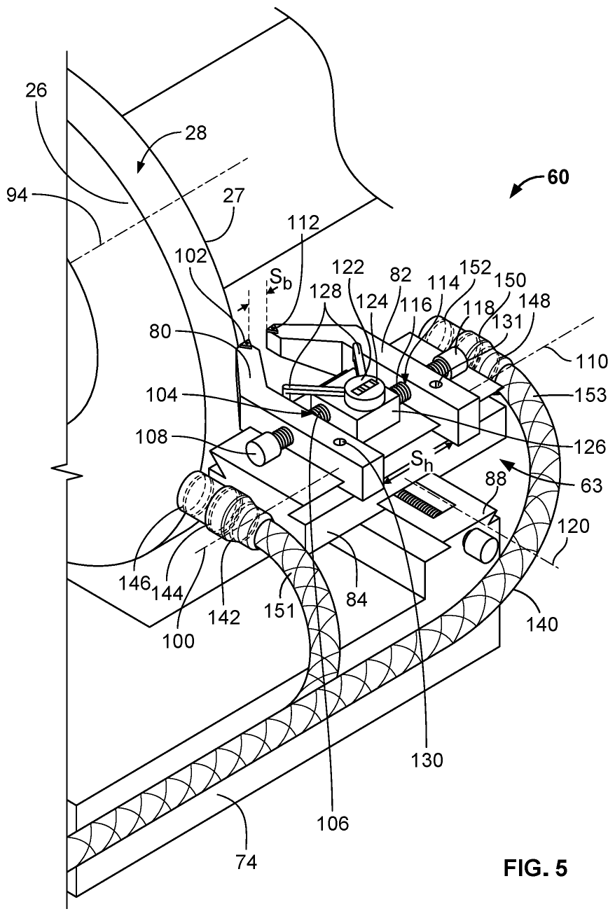

In accordance with some example implementations, the on-vehicle disk brake lathe system 50 is arranged like the on-vehicle disk brake lathe system 60 shown in FIG. 3 to FIG. 5. In accordance with at least some of those implementations, the cutting mechanism 52 is arranged like the cutting mechanism 63 shown in FIG. 3, the brake disk drive unit 54 is arranged like the brake disk drive unit 61, and/or the capture device 56 is arranged like the capture device 90 (shown in FIG. 3), the capture device 140 (shown in FIG. 5), the capture device 200 (shown in FIG. 8), the capture device 306 (shown in FIG. 9) and/or the capture device 532 (shown in FIG. 22).

In accordance with some example implementations, the on-vehicle disk brake lathe system 50 is arranged like the on-vehicle disk brake lathe system 300 shown in FIG. 9 to FIG. 15. In accordance with at least some of those implementations, the cutting mechanism 52 is arranged like the cutting mechanism 302 shown in FIG. 9, the brake disk drive unit 54 is arranged like the brake disk drive unit 304, and/or the capture device 56 is arranged like the capture device 306.

In accordance with some other example implementations, the on-vehicle disk brake lathe system 50 is arranged like the on-vehicle disk brake lathe system 500 shown in FIG. 19 to FIG. 24. In accordance with at least some of those implementations, the cutting mechanism 52 is arranged like the cutting mechanism 530 shown in FIG. 22, the brake disk drive unit 54 is arranged like the brake disk drive unit 502, and/or the capture device 56 is arranged like the capture device 532.

Next, FIG. 3 is an isometric view of the on-vehicle disk brake lathe system 60 and vehicle aspects 62 of the vehicle 10 in accordance with at least some of the example implementations. The vehicle aspects 62 include the wheel hub 30, the brake disk 28, the first disk surface 26, i.e., an out-board friction face, and the second disk surface 27, i.e., an in-board friction face. The first disk surface 26 and the second disk surface 27 are arranged for contacting friction material of a pair of brake pads (not shown).

The on-vehicle disk brake lathe system 60 is attachable to a vehicle in order to machine a brake disk while the brake disk remains attached to a wheel hub and rotates about a wheel hub axis, such as the wheel hub axis 72 of the wheel hub 30. The on-vehicle disk brake lathe system 60 is removably attachable to the wheel hub 30. A wheel hub adaptor, examples of which are shown in FIG. 26, can connect to both the on-vehicle disk brake lathe system 60 and to the wheel hub 30. A variety of wheel hub adaptors can be used with an on-vehicle disk brake lathe system so that the on-vehicle disk brake lathe system can machine various configurations of brake disks.

The on-vehicle disk brake lathe system 60 includes a brake disk drive unit 61 and a cutting mechanism 63 and a capture device 90. The cutting mechanism 52 in FIG. 2 can be arranged like the cutting mechanism 63. The brake disk drive unit 54 shown in FIG. 2 can be arranged like the cutting mechanism 63. The capture device 56 shown in FIG. 2 can be arranged like the capture device 90. An image captured by the capture device 90 can be displayed on a display 92.

The on-vehicle disk brake lathe system 60 includes a frame 74 which is mounted with respect to the vehicle that includes the vehicle aspects 62. The frame 74 is supported by the attachment of the on-vehicle disk brake lathe system 60 to the wheel hub 30. To prevent rotation of the on-vehicle disk brake lathe system 60, the frame 74 can also be supported by attachment to the vehicle or can be mounted with respect thereto via a trolley 76. The frame 74 can be referred to as a lathe body.

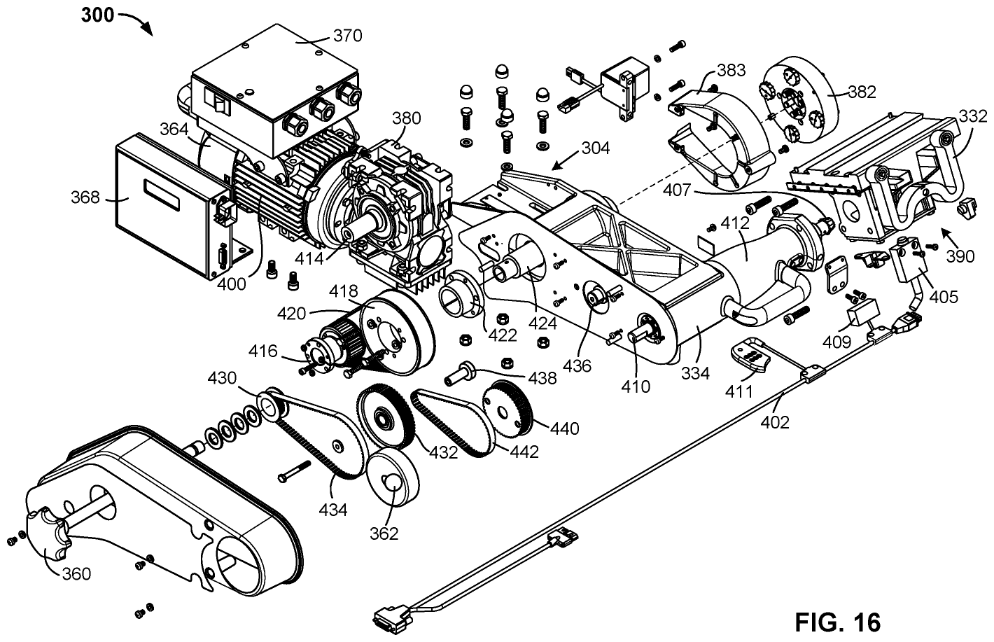

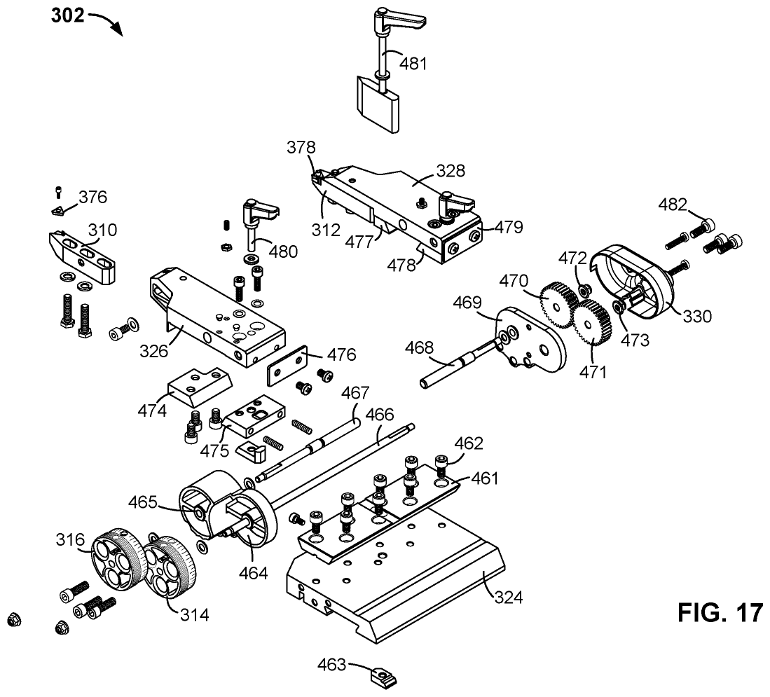

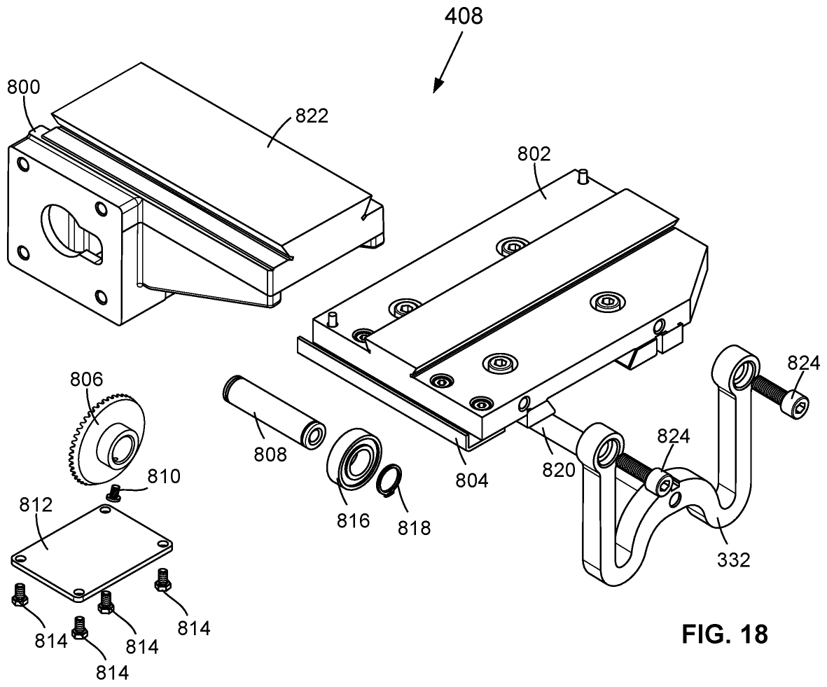

The brake disk drive unit 61 includes a motor 78. The motor includes and/or is attached to a motor connection 65. The motor connection 65 includes and/or is attached to a gear box 67. A wheel hub adaptor 69 is removably attachable to the wheel hub 30. The wheel hub adaptor 69 can be removably attached to the motor connection 65. As an example, the wheel hub adaptor 69 can connect to the motor connection 65 via the gear box 67. In at least some implementations, the gear box 67 can be arranged like the gear box 380 shown in FIG. 16. The motor 78 is configured to rotate the wheel hub 30 and the brake disk 28 about the wheel hub axis 72.

The cutting mechanism 63 includes a first tool holder 80, a second tool holder 82, a platform 84, a displacement gauge 86, and a base 88 to which the platform 84 is translatably mounted. The cutting mechanism 63 also includes and/or is attached to the frame 74. The frame 74 is attached to the motor 78. The platform 84 can be part of the frame 74. A variety of mechanical and electromechanical activating devices such as a screw mechanism, a stepping motor, a servo, a rack-and-pinion mechanism, a hydraulic actuator and/or a pneumatic actuator can be disposed within the frame 74 for moving the first tool holder 80 and the second tool holder 82. Movement of the first tool holder 80 and the second tool holder 82 can occur indirectly by movement of the platform 84. In at least some implementations, the cutting mechanism 63 is arranged like the cutting mechanism 302 shown in FIG. 9 and/or the brake disk drive unit 61 is arranged like the brake disk drive unit 304 shown in FIG. 9.

The on-vehicle disk brake lathe system 60 has a lathe axis 94 which is aligned with the wheel hub axis 72 when the on-vehicle disk brake lathe system 60 is operated. Means to align the wheel hub axis 72 with the lathe axis 94 are discussed and equipment to automate the alignment procedure is set forth in U.S. Pat. Nos. 5,653,153, 5,974,878, 6,050,160, and 6,101,911. U.S. Pat. Nos. 5,653,153, 5,974,878, 6,050,160, and 6,101,911 are incorporated herein by reference.

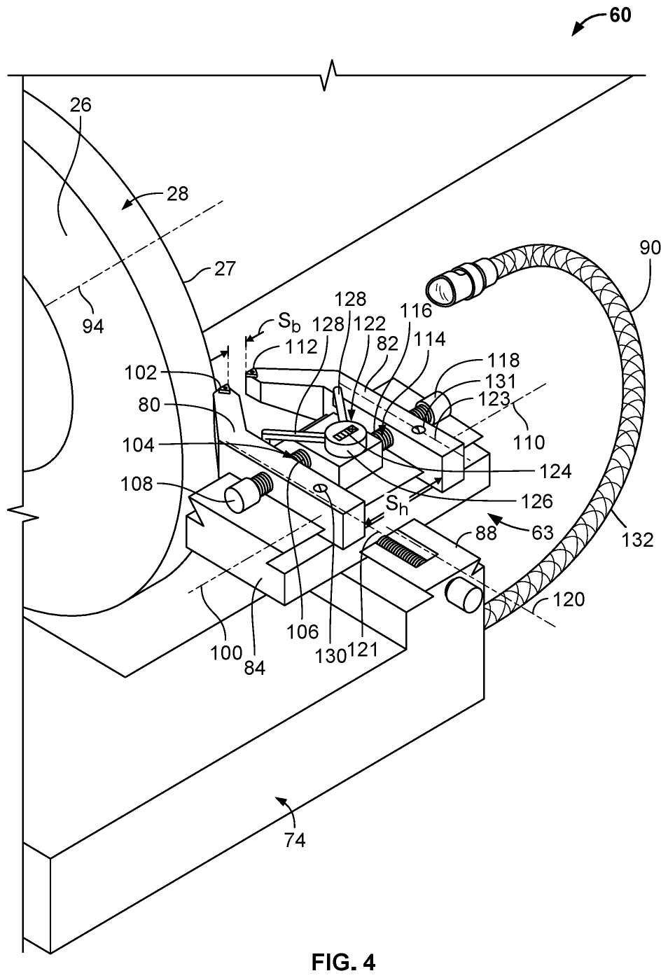

Next, FIG. 4 shows additional details of the on-vehicle disk brake lathe system 60. In particular, FIG. 4 shows that the on-vehicle disk brake lathe system 60 includes the first tool holder 80 which slidably engages the platform 84 and traverses a first tool holder path 100 which is parallel to the lathe axis 94. A first tool bit 102 is attached to the first tool holder 80 and is configured to resurface the first disk surface 26. A first holder threaded shaft 104 terminates in a first shaft end 106 and a first knob 108. The first shaft end 106 is rotatably mounted to the platform 84, and the first holder threaded shaft 104 threadably engages the first tool holder 80. Turning the first knob 108 adjusts the normal component of a spatial separation of the first tool bit 102 with respect to the first disk surface 26 of the brake disk 28.

Similarly, the on-vehicle disk brake lathe system 60 includes a second tool holder 82 which slidably engages the platform 84 and traverses a second tool holder path 110 which is parallel to the lathe axis 94. A second tool bit 112 which is attached to the second tool holder 82 is configured to resurface the second disk surface 27. A second holder threaded shaft 114 terminates in a second shaft end 116 and a second knob 118. The second holder threaded shaft 114 is rotatably mounted to the platform 84, and the second holder threaded shaft 114 threadably engages the second tool holder 82. Turning the second knob 118 independently adjusts the normal component of a spatial separation of the second tool bit 112 with respect to the second disk surface 27 of the brake disk 28.

The frame 84 has a base 88 to which the platform 84 is translatably mounted. The platform 84 is movable along a feed path 120 which is normal to the lathe axis 94. When the separation between the first tool bit 102 and a plane containing the first disk surface 26 and/or the spatial separation between the second tool bit 112 and a plane containing the second disk surface 27 are negative, the first tool bit 102 and the second tool bit 112 can be advanced into machining engagement so as to resurface the first disk surface 26 and the second disk surface 27. The first tool bit 102 is movable along a feed path 121 and the second tool bit 112 is movable along a feed path 123. The feed path 121, 123 are normal to the lathe axis 94 and parallel to each other and to the feed path 120.

A displacement gauge 122 is positioned such that it measures the separation Sₕ between the first tool holder 80 and the second tool holder 82. Since the separation Sₕ varies directly as the separation S_{b} of the first tool bit 102 and the second tool bit 112, by calibrating the displacement gauge 122 such that it has a base value when the first tool bit 102 and the second tool bit 112 are in contact with each other, the separation S_{b} of the first tool bit 102 and the second tool bit 112 can be readily monitored. A variety of gauges are suitable for this purpose. These gauges can have either digital or analog output and may or may not be integrated with other elements such that they are capable of providing a direct reading of the separation S_{b} of the first tool bit 102 and the second tool bit 112. The displacement gauge 122 illustrated has a display 124 which, in this implementation, serves as means for outputting the signal from the displacement gauge 122. The displacement gauge 122 can be calibrated such that, when the first tool bit 102 and the second tool bit 112 are in contact with each other, the reading of the displacement gauge 122 is set to zero and this separation is shown on the display 124. The displacement gauge 122 in this implementation is a rotary displacement gauge having a gauge body 126, which is mounted to the platform 84, and sensing elements 128 which engage the first tool holder 80 and the second tool holder 82. A more extensive treatment of gauge technology is found in U.S. Pat. No. 5,970,427.

As the first tool bit 102 and the second tool bit 112 traverse the first disk surface 26 and the second disk surface 27, a force normal to the first disk surface 26 and the second disk surface 27, is generated which is to be balanced by a reaction force to avoid displacement of the first tool bit 102 and the second tool bit 112. The frictional forces associated with the respective threadable engagement of the first holder threaded shaft 104 and the second holder threaded shaft 114 with the first tool holder 80 and the second tool holder 82 are configured to maintain the first tool bit 102 and the second tool bit 112 in position. In at least some implementations (e.g., where these frictional forces are not sufficient), the on-vehicle disk brake lathe system 60 includes supplemental securing means for holding the first tool holder 80 and the second tool holder 82 in a fixed axial position relative to the platform 84. As an example, the supplemental securing means can include a set screw 130, 131 to serve as a lock which prevents movement of the first tool bit 102 and the second tool bit 112, respectively, parallel to the first tool holder path 100 and the second tool holder path 110 when the brake disk 28 is being resurfaced by the first tool bit 102 and the second tool bit 112. In a more automated lathe, locks which are activated by solenoids or electromechanical means are better suited for securing the tool holders than manually activated locks.

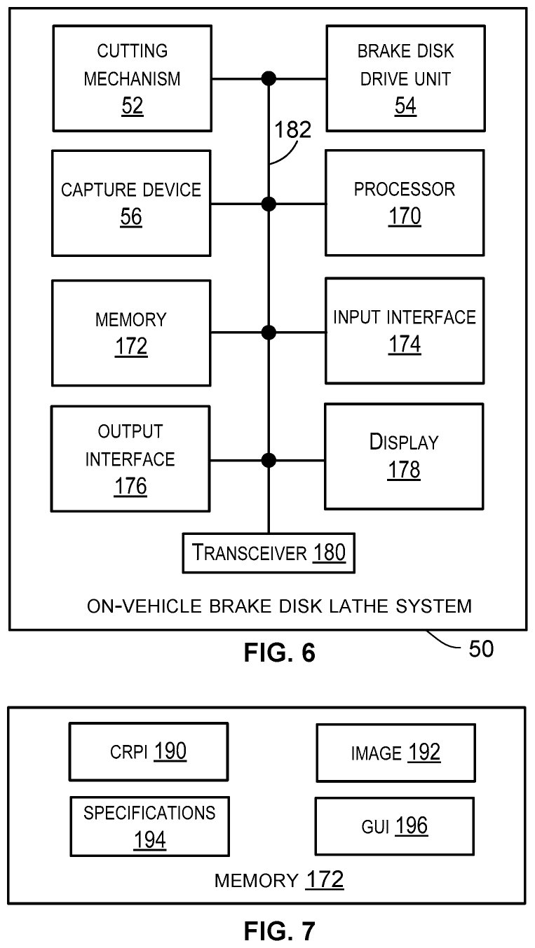

The capture device 90 can include an image sensor, a lens, and a flexible housing 132. An example arrangement of the image sensor and the lens is shown in FIG. 8. The flexible housing 132 can be moved so that the image sensor can receive infrared radiation, visible light radiation, and/or ultraviolet radiation reflected from at least a portion of the brake disk 28 and/or from at least a portion of the cutting mechanism 63. The capture device 90 or any other capture device described in this description can also include and/or attach to a bus for carrying signals, such as image data generated at the image sensor, to a display. As an example, the bus can include a bus arranged according to a universal serial bus (USB) specification maintained by the USB Implementers Forum (USB-IF) of Beaverton, Oreg. For purposes of this description, such a bus is referred to as a “USB bus.” As an example, the USB specification can be the USB-3.0, USB-3.1, USB-3.2, USB-4, or another USB specification. Other examples of the bus and a specification for communicating over the bus are also possible. Moreover, the bus can be a wireless communication link (e.g., a radio frequency air interface). The capture device 90 and the display 92 can be operatively connected to each other via a harness or bus. The display 92 can be arranged as and/or include the display 178 (shown in FIG. 6). The capture device 90 can include a borescope.

Next, FIG. 5 shows an alternative arrangement of the on-vehicle disk brake lathe system 60. In this alternative arrangement, the on-vehicle disk brake lathe system 60 includes a capture device 140. The capture device 140 is configured to be able to capture an image of the first disk surface 26 and an image of the second disk surface 27. Additionally or alternatively, the images captured by the capture device 140 can include an image that shows the first tool holder 80 and/or the first tool bit 102, and/or an image that shows the second tool holder 82 and/or the second tool bit 112.

In at least some implementations, the capture device 140 includes an image sensor 142, a lens 144, and a light source 146 for capturing the image of the first disk surface 26, and an image sensor 148, a lens 150, and a light source 152 for capturing the image of the second disk surface 27. The capture device 140 can include a bus for carrying signals, such as image data generated at the image sensor 142, 148, to the display 92.

The capture device 140 can include a flexible housing 151 that can be moved so that the image sensor 142 can receive infrared radiation, visible light radiation, and/or ultraviolet radiation reflected from at least a portion of the brake disk 28 and/or from at least a portion of the cutting mechanism 63. Likewise, the capture device 140 can include a flexible housing 153 that can be moved so that the image sensor 148 can receive infrared radiation, visible light radiation, and/or ultraviolet radiation reflected from at least a portion of the brake disk 28 and/or from at least a portion of the cutting mechanism 63. The capture device 140 can include a borescope.

Next, FIG. 6 is another block diagram of the on-vehicle disk brake lathe system 50 in accordance with at least some of example implementations. As shown in FIG. 6, the on-vehicle disk brake lathe system 50 includes the cutting mechanism 52, the brake disk drive unit 54, the capture device 56, a processor 170, a memory 172, an input interface 174, an output interface 176, a display 178, and a transceiver 180. Two or more of the aforementioned components of the on-vehicle disk brake lathe system 50 can be operatively connected to each other using a bus 182. The bus 182 can include one or more busses, such as a data bus and/or an electrical power bus. The bus 182 can include a USB bus.

1. Processor

A processor, such as the processor 170 or any other processor discussed in this description, can include one or more processors. Any processor discussed in this description can thus be referred to as “at least one processor” or “one or more processors.” Furthermore, any processor discussed in this description can include a general purpose processor (e.g., an INTEL® single core microprocessor or an INTEL® multicore microprocessor), a special purpose processor (e.g., a digital signal processor, a graphics processor, an embedded processor, a field-programmable gate array (FPGA), or an application specific integrated circuit (ASIC) processor). Furthermore still, any processor discussed in this description can include or be operatively connected to a memory controller that controls a flow of data going to and from a memory, such as the memory 172.

Any processor discussed in this description can be configured to execute computer-readable program instructions (CRPI). Any CRPI discussed in this description can, for example, include assembler instructions, machine instructions, machine dependent instructions, microcode, firmware instructions, state-setting data, and/or either source code or object code written in one or any combination of two or more programming languages. As an example, a programming language can include an object oriented programming language such as Java, Python, or C++, or a procedural programming language, such as the “C” programming language. Any processor discussed in this description can be configured to execute hard-coded functionality in addition to or as an alternative to software-coded functionality (e.g., via CRPI).

An embedded processor refers to a processor with a dedicated function or functions within a larger electronic, mechanical, pneumatic, and/or hydraulic device, and is contrasted with a general purpose computer. As an example, the dedicated function(s) can include function(s) to control the brake disk drive unit 54 and/or function(s) to control movement of the cutting mechanism 52. The embedded processor can include a central processing unit chip used in a system that is not a general-purpose workstation, laptop, or desktop computer. In some implementations, the embedded processor can execute an operating system, such as a real-time operating system (RTOS). As an example, the RTOS can include the SMX® RTOS developed by Micro Digital, Inc., such that the embedded processor can, but need not necessarily, include (a) an advanced RISC (reduced instruction set computer) machine (ARM) processor (e.g., an AT91SAM4E ARM processor provided by the Atmel Corporation, San Jose, Calif.), or (b) a COLDFIRE® processor (e.g., a 52259 processor) provided by NXP Semiconductors N.V., Eindhoven, Netherlands. A general purpose processor, a special purpose processor, and/or an embedded processor can perform analog signal processing and/or digital signal processing.

In at least some implementations that include multiple processors, the multiple processors are distributed. As an example, the distributed processors can include a processor in a computer box (such as the computer box 368 shown in FIG. 9) and a processor in a tablet computer having a display, such as a tablet computer including the display 92 shown in FIG. 3, a tablet computer including the display 366 shown in FIG. 9, or a tablet computer including the display 520 shown in FIG. 19. In at least some implementations, the display 92, 366, 520 is not included as part of a tablet computer.

2. Memory

Memory, such as the memory 172 or any other memory discussed in this description, can include one or more memories. Any memory discussed in this description can thus be referred to as “at least one memory” or “one or more memories.” A memory can include a non-transitory memory, a transitory memory, or both a non-transitory memory and a transitory memory. A non-transitory memory, or a portion thereof, can be located within or as part of a processor (e.g., within a single integrated circuit chip). A non-transitory memory, or a portion thereof, can be separate and distinct from a processor.

A non-transitory memory can include a volatile or non-volatile storage component, such as an optical, magnetic, organic or other memory or disc storage component. Additionally or alternatively, a non-transitory memory can include or be configured as a random-access memory (RAM), a read-only memory (ROM), a programmable read-only memory (PROM), an erasable programmable read-only memory (EPROM), a flash memory, an electrically erasable programmable read-only memory (EEPROM), or a compact disk read-only memory (CD-ROM). The RAM can include static RAM or dynamic RAM. A non-transitory memory can be configured as a removable storage device, a non-removable storage device, or a combination thereof. A removable storage and/or a non-removable storage device can, but need not necessarily, include a magnetic disk device such as a flexible disk drive or a hard-disk drive (HDD), an optical disk drive such as a compact disc (CD) drive and/or a digital versatile disk (DVD) drive, a solid state drive (SSD), or a tape drive.

A memory can be referred to by other terms such as a “computer-readable memory,” a “computer-readable medium,” a “computer-readable storage medium,” a “data storage device,” a “memory device,” “computer-readable media,” a “computer-readable database,” “at least one computer-readable medium,” or “one or more computer-readable mediums.” Any of those alternative terms can be preceded by the prefix “transitory” if the memory is transitory or “non-transitory” if the memory is non-transitory. For a memory including multiple memories, two or more of the multiple memories can be the same type of memory or different types of memories. A transitory memory can include, for example, CRPI provided over a communication bus, such as the bus 182.

3. Input Interface

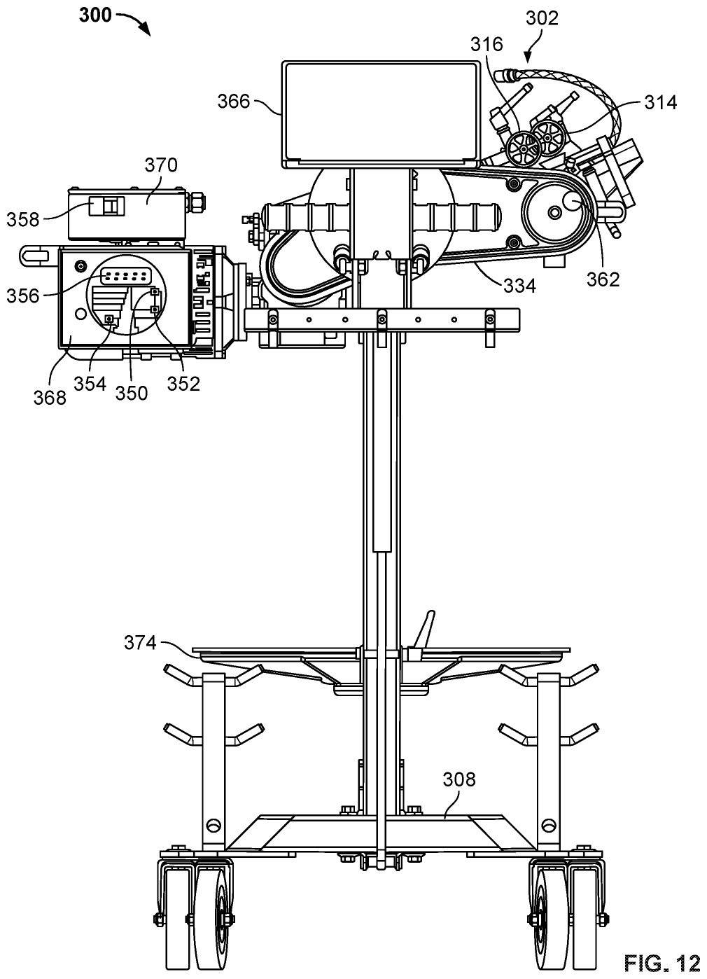

The input interface 174 includes one or more components for inputting data and/or signals to the on-vehicle disk brake lathe system 50 and/or another component of the on-vehicle disk brake lathe system 50. As an example, the input interface 174 can include a start switch (e.g., a start switch 350 shown in FIG. 12), a reset switch (e.g., a reset switch 352 shown in FIG. 12), and/or a calibration switch (e.g., a calibration switch 354 shown in FIG. 12). The start switch 350 can be used to initiate rotation of a wheel hub and brake disk and/or to initiate movement of the cutting mechanism 52 along feed path(s). The reset switch 352 can be used to move the cutting mechanism 52 back to a start position and then to resume movement of the cutting mechanism 52 along the feed path(s). The calibration switch 354 can cause the processor 170 to execute a calibration routine to calibrate the on-vehicle disk brake lathe system 50. As another example, the input interface 174 can include a feed engagement knob (e.g., a feed engagement knob 362 (also known as a clutch knob) shown in FIG. 9). In at least some implementations, the display 178 is configured as and/or includes a touch screen display such that the display 178 can function as at least a part of the input interface 174.

As an example, a switch of the input interface 174 or any other switch described in this description can include a switch for switching between two states or for switching between more than two states. Examples of a switch for switching between two states include a toggle switch configured to switch between an on state and an off state and a push button switch or a toggle switch. As example of a switch for switching between more than two states includes a rotary switch or dial with more than two positions.

4. Output Interface

The output interface 176 includes one or more components for outputting data and/or signals by the on-vehicle disk brake lathe system 50. As an example, the output interface 176 can include a light emitting diode (LED) display (e.g., an LED numerical display 356 shown in FIG. 12) and/or an LED for indicating status of the on-vehicle disk brake lathe system 50. In at least some implementations, the display 178 is configured as and/or includes a touch screen display such that the display 178 can function as at least a part of the output interface 176.

5. Display

The display 178 can include one or more displays. As an example, each display of the one or more displays includes a capacitive touch screen display, a resistive touch screen display, a plasma display, a light emitting diode (LED) display, a cathode ray tube display, an organic light-emitting diode (OLED) display (such as an active-matrix OLED or a passive-matrix OLED), a liquid crystal display (LCD) (such as include a backlit, color LCD), a touch screen display with the LCD, a capacitive touch screen display, or a resistive touch screen display. The display 178 can include a different type of display as well or instead. In at least some implementations, the display 178 is contained within a tablet touch screen device.

The display 178 is configured to display data captured by a capture device, such as the capture device 56, 90, 140, 306, 532. As an example, the display 178 can display a still image (such as a visible light image, a thermal image, and/or a blended image based on a visible light image and a thermal image). As another example, the display 178 can display a video.

In at least some implementations, the display 178 is configured to display a graphical user interface (GUI), such as a GUI 196 stored in the memory 172. As an example, GUI 196 can include vehicle identifying information corresponding to the vehicle 10, such as a year, make, and model associated with the vehicle 10, and/or a vehicle identification number associated with the vehicle 10. As another example, the GUI 196 can include a specification 194, such as a machining specification, and/or a measurement pertaining to a brake disk. For instance, the specification 194 can be indicative of lateral runout of the brake disk and a machine-to specification indicative of a minimum brake disk thickness to machining the brake disk and advising a user whether machining the brake disk is recommended. The measurements, for instance, can indicate lateral runout measurements and brake disk thicknesses before and after machining of the brake disk. At least some of the content displayed on the display 178 can include content provided from the computer box 368.

6. Transceiver

The transceiver 180 can include one or more transceivers. Each transceiver includes one or more transmitters configured to transmit data onto a network. Each transceiver includes one or more receivers configured to receive data or a communication carried over a network. Unless stated differently, any data described as being transmitted to a device or system is considered to be received by that device or system. Similarly, unless stated differently, any data described as being received from a device or system is considered to be transmitted by that device or system directly or indirectly to the receiving device or system. For some implementations, a transceiver can include a transmitter and a receiver in a single semiconductor chip. In at least some of those implementations, the semiconductor chip can include a processor.

In at least some of the example implementations, a transmitter within the transceiver 180 transmits radio signals carrying data, and a receiver within the transceiver 180 receives radio signals carrying data. A transceiver with a radio transmitter and radio receiver can include one or more antennas and can be referred to as a “radio transceiver,” an “RF transceiver,” or a “wireless transceiver.” “RF” represents “radio frequency.”

A radio signal transmitted or received by a radio transceiver can be arranged in accordance with one or more wireless communication standards or protocols such as an IEEE® standard, such as (i) an IEEE® 802.11 standard for wireless local area networks (wireless LAN) (which is sometimes referred to as a WI-FI® standard) (e.g., 802.11a, 802.11b, 802.11g, or 802.11n), (ii) an IEEE® 802.15 standard (e.g., 802.15.1, 802.15,3, 802.15.4 (ZIGBEE®), or 802.15.5) for wireless personal area networks (PANs), (iii) a BLUETOOTH® version 4.1 or 4.2 standard developed by the Bluetooth Special Interest Group (SIG) of Kirkland, Wash., (iv) a cellular wireless communication standard such as a long term evolution (LTE) standard, (v) a code division multiple access (CDMA) standard, (vi) an integrated digital enhanced network (IDEN) standard, (vii) a global system for mobile communications (GSM) standard, (viii) a general packet radio service (GPRS) standard, (ix) a universal mobile telecommunications system (UMTS) standard, (x) an enhanced data rates for GSM evolution (EDGE) standard, (xi) a multichannel multipoint distribution service (MMDS) standard, (xii) an International Telecommunication Union (ITU) standard, such as the ITU-T G.9959 standard referred to as the Z-Wave standard, (xiii) a 6LoWPAN standard, (xiv) a Thread networking protocol, (xv) an International Organization for Standardization (ISO/International Electrotechnical Commission (IEC) standard such as the ISO/IEC 18000-3 standard for Near Field Communication (NFC), (xvi) the Sigfox communication standard, (xvii) the Neul communication standard, (xviii) the LoRaWAN communication standard, or a 5G new radio (5G NR) communication standard by the 3^{rd} Generation Partnership Project (3GPP) standards organization, such as the 5G NR, phase 1 or 5G NR, phase 2 communication standard. Other examples of the wireless communication standards or protocols are possible.

In at least some of the implementations, a transmitter within the transceiver 180 can be configured to transmit a signal (e.g., one or more signals or one or more electrical waves) carrying or representing data onto an electrical circuit (e.g., one or more electrical circuits of a communication network). Similarly, a receiver within the transceiver 180 can be configured to receive via an electrical circuit a signal carrying or representing data over the electrical circuit. The signal carried over an electrical circuit can be arranged in accordance with a wired communication standard such as a Transmission Control Protocol/Internet Protocol (TCP/IP), an IEEE® 802.3 Ethernet communication standard for a LAN, a data over cable service interface specification (DOCSIS standard), such as DOCSIS 3.1, a universal serial bus (USB) specification, or some other wired communication standard or protocol. An electrical circuit can include a wire, a printed circuit on a circuit board, and/or a network cable (e.g., a single wire, a twisted pair of wires, a fiber optic cable, a coaxial cable, a wiring harness, a power line, a printed circuit, a CAT5 cable, and/or CAT6 cable). The wire can be referred to as a “conductor”. Transmission of data over the conductor can occur electrically and/or optically.

In at least some implementations, the transceiver 180 includes a modem, a network interface card, a local area network (LAN) on motherboard (LOM), and/or a chip mountable on a circuit board. As an example, the chip can include a CC3100 Wi-Fi® network processor available from Texas Instruments, Dallas, Tex., a CC256MODx Bluetooth® Host Controller Interface (HCl) module available from Texas instruments, or a different chip for communicating via Wi-Fi®, Bluetooth® or another communication protocol.

A network node that is within and/or coupled to a communication network using a packet-switched technology can be locally configured for a next ‘hop’ in the network (e.g., a device or address where to send data to, and where to expect data from). As an example, a device (e.g., a transceiver) configured for communicating using an IEEE® 802.11 standard can be configured with a network name, a network security type, and a password. Some devices auto-negotiate this information through a discovery mechanism (e.g., a cellular phone technology).

The transceiver 180 can be arranged to transmit a request and/or receive a response using a transfer protocol, such a hypertext transfer protocol (i.e., HTTP), an HTTP over a secure socket link (SSL) or transport layer security (TLS) (i.e., HTTPS), a file transfer protocol (i.e., FTP), or a simple mail transfer protocol (SMTP). The transceiver 180 can be arranged to transmit an SMS message using a short message peer-to-peer protocol or using some other protocol.

The data transmitted by the transceiver 180 can include a destination identifier or address of a computing device to which the data is to be transmitted. The data or communication transmitted by the transceiver 180 can include a source identifier or address of the on-vehicle disk brake lathe system 50. The source identifier or address can be used to send a response to the on-vehicle disk brake lathe system 50.

As an example, the transceiver 180 can transmit an image captured by the captured device 56 to a database and/or a database server. The database server can store the image in the database for subsequent retrieval of the image. The image stored at the database can be correlated with a repair order pertaining to the vehicle 10. The database server can provide the stored image to a display device alone or along with the repair order.

7. Memory Content

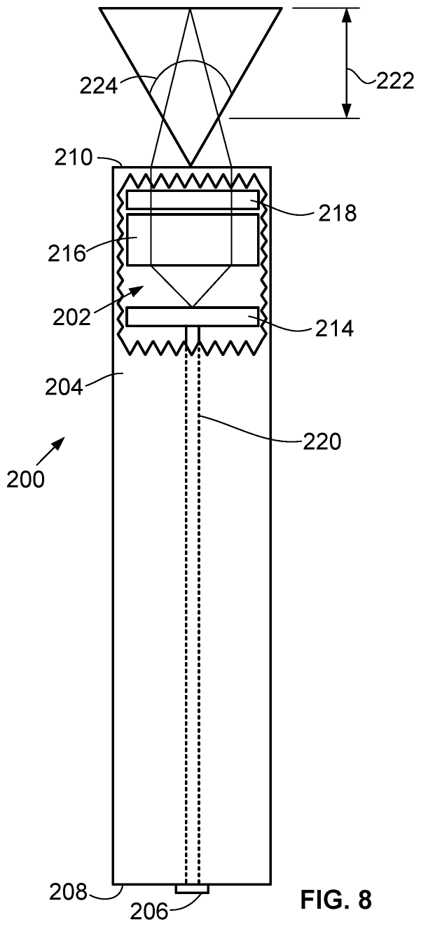

The example implementations can determine, receive, transmit, generate, store, display, and/or use a variety of computer-readable data. At least some of the computer-readable data can be stored in a memory, such as the memory 172. FIG. 7 is a block diagram representing the memory 172 in accordance with at least some example implementations. As shown in FIG. 7, the memory 172 contains CRPI 190, an image 192, a specification 194, and/or the GUI 196.

The image 192 can include one or more images captured by the capture device 56 or another capture device described in this description. The processor 170 can write into the memory 172 metadata regarding a stored image, such as a time stamp, a date stamp, vehicle identifying information, and/or a job identifier.

In at least some implementations, the CRPI 190 includes instructions executable to control movement of the cutting mechanism 52 and movement of the brake disk drive unit 54.

In at least some implementations, the CRPI 190 includes instructions executable to output content to the display 178, such as an image captured by the capture device 56 and/or a GUI. Moreover, in at least some implementations, the instructions to output an image captured by a capture device and/or a GUI for displaying an image captured by the capture device can be written into the memory 172 after the on-vehicle disk brake lathe system has machined at least one brake disk. In other words, an on-vehicle disk brake lathe system without instructions to output an image captured by a capture device and/or a GUI for displaying an image captured by the capture device can be modified to include such instructions. As an example, a manufacturer of the on-vehicle disk brake lathe system can transmit (e.g., download) the instructions to the transmitter 180 over the Internet and the processor 170 can write the instructions received by the transmitter 180 into the memory 172. Furthermore, the capture device of the on-vehicle disk brake lathe system can be installed thereon after the on-vehicle disk brake lathe system has machined at least one brake disk.

In at least some implementations, the CRPI 190 includes instructions executable to perform the following functions: capturing a first thermal image showing at least a portion of the brake disk before the on-vehicle disk brake lathe system rotates the brake disk; determining a first temperature value represented by the first thermal image; capturing a second thermal image showing at least a portion of the brake disk while the on-vehicle disk brake lathe system rotates the brake disk; determining a second temperature value represented by the second thermal image; determining, based on a comparison of the first temperature value and the second temperature value, whether or not the first cutting tip is in contact with the in-board friction face or whether or not the second cutting tip is in contact with the out-board friction face; and outputting a notification indicative of whether or not the first cutting tip is in contact with the in-board friction face or whether or not the second cutting tip is in contact with the out-board friction face.

As an example for the aforementioned implementations, the portion of the brake disk shown in the first thermal image and the portion of the brake disk shown in the second thermal image can include a portion of the in-board friction face of the brake disk or a portion of the out-board friction face of the brake disk. As another example for the aforementioned implementations, the second thermal image can further show one or more metallic chips removed from the brake disk by the first cutting tool or by the second cutting tool. Moreover, the second temperature value can be based at least in part on a temperature value associated with at least some of the one or more metallic chips. The image 950 shown in FIG. 32 is an example of the second thermal image.

In at least some implementations, the CRPI 190 can include instructions executable to adjust a rate at which a feed mechanism and/or a cutting mechanism moves a cutting tip along a feed path based on a temperature determined from an image captured by the capture device 56. The determined temperature can be a temperature of a cutting tip of a cutting tool, a cutting tool, and/or a brake disk. Execution of those program instructions can include the processor 170 comparing the determined temperature to one or more threshold temperatures. Each threshold temperature can be correlated with a speed at which the feed mechanism and/or the cutting mechanism is configured to be moved. The processor 170 can adjust the speed of the feed mechanism and/or the cutting mechanism in an attempt to lower a temperature of the brake disk, cutting tip and/or cutting tool below a threshold temperature and/or raise a speed of the feed mechanism and/or the cutting mechanism to reduce an amount of time taken to machine the brake disk while keeping the temperature determined from a captured image below a threshold temperature. In at least some implementations, moving the feed mechanism at a slower rate and applying the cutting mechanism so that the cutting tool applies a smaller force against the brake disk can increase the usable life of the cutting tool. The trade-off is cutting time versus cutting tool lifetime. Furthermore, the processor 170 can optimize for machining of the brake disk and extending tool life by adjusting the cutting mechanism so that the cutting tools contact the brake disk with a minimum force that allows the cutting tools to cut the entirety of the friction faces of the brake disk.

In at least some implementations, the CRPI 190 includes instructions to detect the brake disk and/or the cutting tool within images captured by the capture device 56. Those instructions can be configured to cause the processor 170 to process the captured images using edge detection in order to determine boundaries of an object in the images, such as the brake disk, the cutting tool, or a chip removed from the brake disk using the cutting tool. In at least some implementations, the processor 170 can determine discontinuities in brightness in the images. Moreover, the program instructions can be configured to perform edge detection using a Sobel edge detection method, a Canny edge detection method, a Prewitt edge detection method, a Roberts edge detection method and/or a fuzzy logic edge detection method. One or more of those methods may incorporate a filter to determine the portions of the image that show the brake disk, cutting tool, and/or chip. The processor 170 can determine one or more temperatures based on pixels of a thermal image showing the determined portions of the image showing the brake disk, cutting tool, and/or chip.

The processor 170 can determine the one or more temperatures of the brake disk, cutting tool, and/or chip for instances when the capture device 56 is receiving radiation reflected and/or emitted from the brake disk, cutting tool, and/or chip. If the capture device 56 is not receiving radiation reflected and/or emitted from the brake disk, cutting tool, and/or chip and thus cannot determine the brake disk, cutting tool, and/or chip within an image, the processor 170 can output a notification indicating the capture device should be aimed at the brake disk, cutting tool, and/or chip.

After the processor 170 initiates movement of rotating the brake disk and movement of the cutting tools, the processor 170 can detect the brake disk and the cutting tools within the captured images and then determine whether the brake disk and/or the cutting tool has a hot spot in some portion of the brake disk and/or the cutting tool. A hot spot of the brake disk or the cutting tool is a portion of the brake disk or the cutting tool, respectively, that has a temperature greater than surrounding portions of the brake disk or the cutting tool.

The processor 170 can compensate edge detection determinations based on a known rate at which the cutting tool is moving along a cutting path. That compensation can include the processor 170 determining that pixels representing a short end of the cutting tool (rather than the longitudinal end of the cutting tool) change in successively captured images in a direction that the cutting tool is moving.

The processor 170 can determine chips from the brake disk by determining edges of the chips shown in successively captured images are moving away from the brake disk by determining that an edge of a determined chip is shown in different pixels in the successively captured images. Moreover, the processor 170 can base a determination that the different pixels represent edges of a chip by determining that pixels representing an edge of a chip change in successively captured images at a rate that exceeds a rate at which a short end of the cutting tool (rather than the longitudinal end of the cutting tool) change in successively captured images in a direction that the cutting tool is moving. In other words, the processor 170 can determine chips with successively captured images by determining that the determined chips are shown as moving faster than a rate at which the cutting tool is shown to be moving in those successively captured images.

Although the brake disk is rotated while being machined, the brake disk can be represented using identical or substantially identical pixels in successively captured images. Accordingly, temperatures of the brake disk and a determination that some portion of a brake disk is a hot spot can occur in real-time or near real-time. Similarly, the cutting tool can move at a rate such that at least a substantial number of pixels used to represent the cutting tool in successively captured images are identical. Accordingly, temperatures of the cutting tool and a determination that some portion of a cutting tool is a hot spot can occur in real-time or near real-time.

In at least some implementations, the CRPI 190 includes instructions executable to use a determination that a cutting tool is not actively cutting a brake disk surface while the cutting tool is traversing a feed path as a trigger to store an image captured by the capture device 56.

After determining pixels in captured thermal images represent a brake disk, cutting tool or chip, the processor 170 can determine a temperature of the brake disk, cutting tool or chip and then output the temperatures on the display 178.

Next, FIG. 8 shows a capture device 200 in accordance with the example implementations. An interior portion of the capture device 200 is visible through an area 202 of the capture device 200 shown as being cut out of a housing 204. In at least some implementations, at least a portion of the housing 204 is flexible to allow the capture device 200 to be repositioned with respect to a cutting mechanism and/or a brake disk. In those or in other implementations, at least a portion of the housing 204 is rigidly attached to another portion of an on-vehicle disk brake lathe system.

The capture device 200 includes a connector 206 at a proximal end 208 (e.g., proximal to a display configured to display an image captured by the capture device, and a distal end 210. In at least some implementation, the connector 206 connects to the processor 170, the input interface 174, the display 178, and/or the bus 182. The capture device 200 also include an image sensor 214, a lens 216, and a light source 218, such as a light emitting diode, configured to emit visible light onto an object, such as a brake disk and/or a cutting mechanism. The capture device 200 also includes a bus 220 for carrying signals, such as image data generated at the image sensor 214, and electrical power to the image sensor 214 and the light source 218. The image sensor 214 and the lens 216 are configured to have a depth of field 222 and a field of view 224. As an example, the depth of field 222 can be 3 mm to 9 mm. As an example, the field of view 224 can be a value between 10° and 120°, inclusive. Other examples of the depth of field 222 and/or the field of view 224 are also possible. The capture device 56, 90, 140, 306, 532 can, but need not necessarily, be configured like the capture device 200. The capture device 306 can include a borescope.

B. Example Implementation of On-Vehicle Disk Brake Lathe System

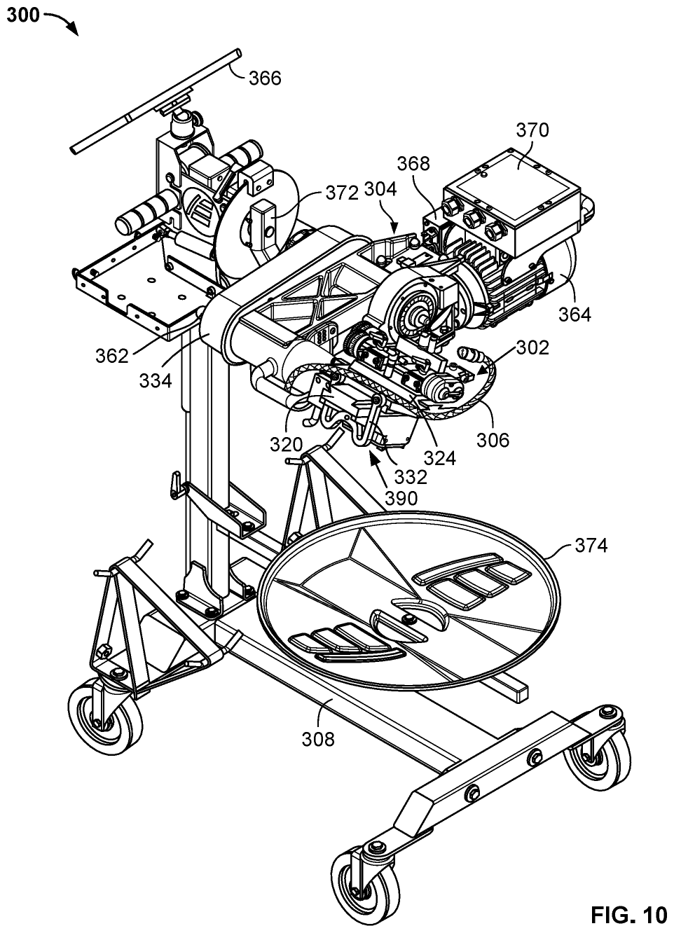

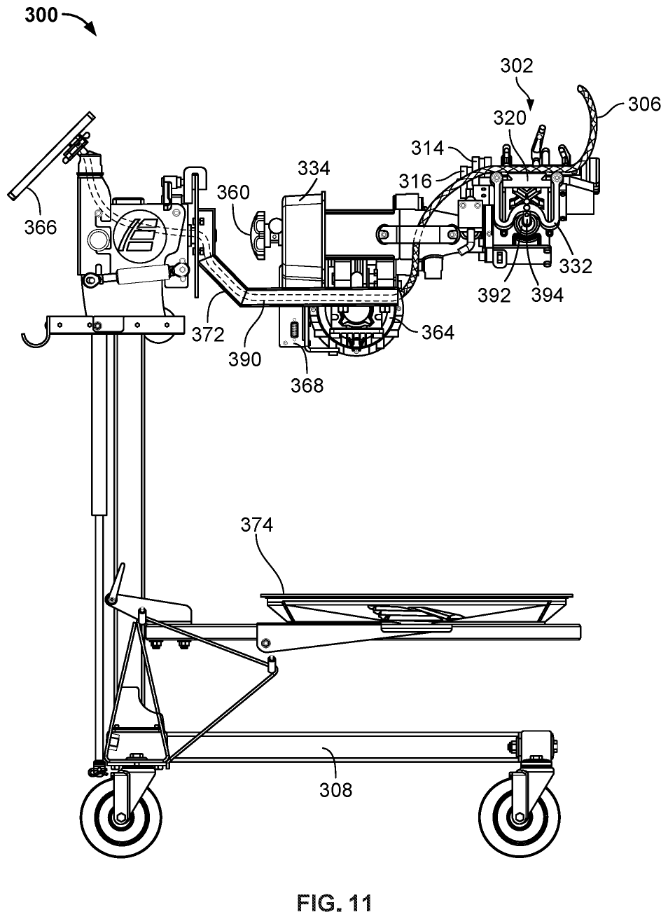

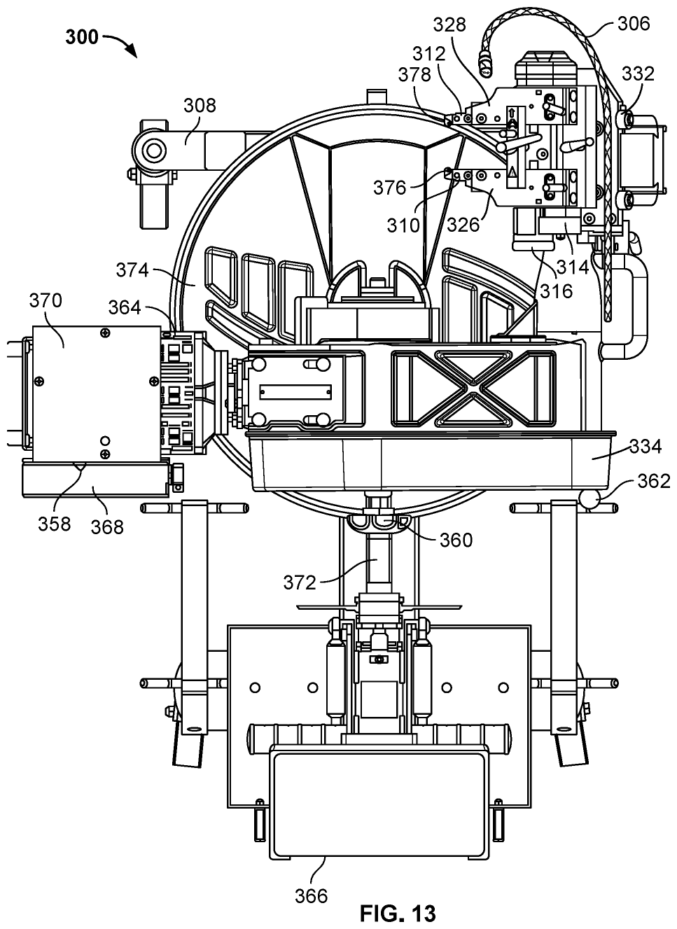

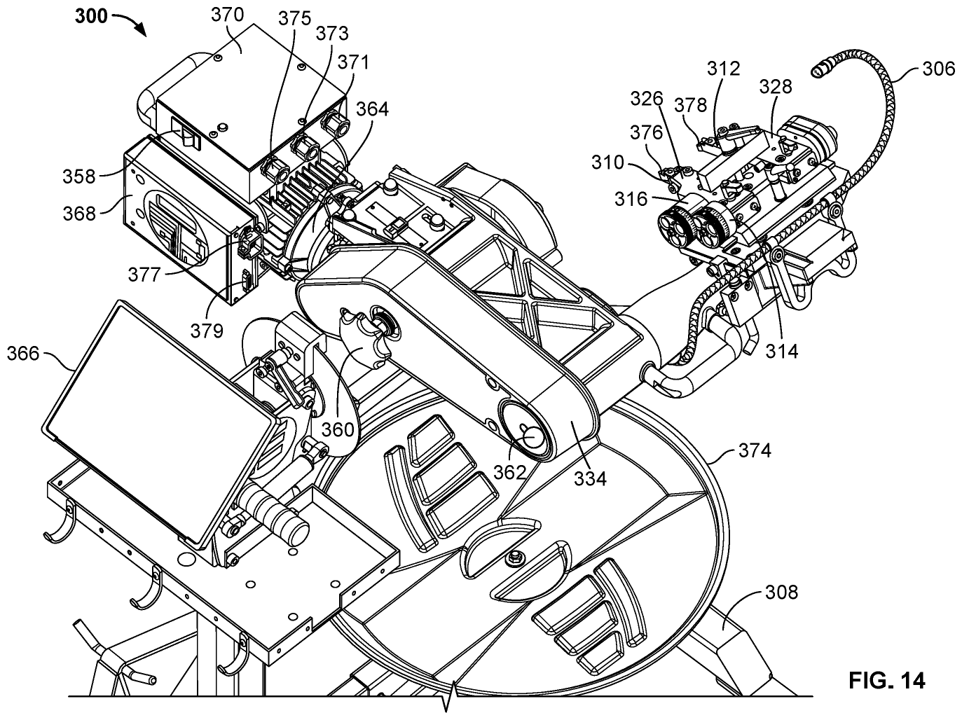

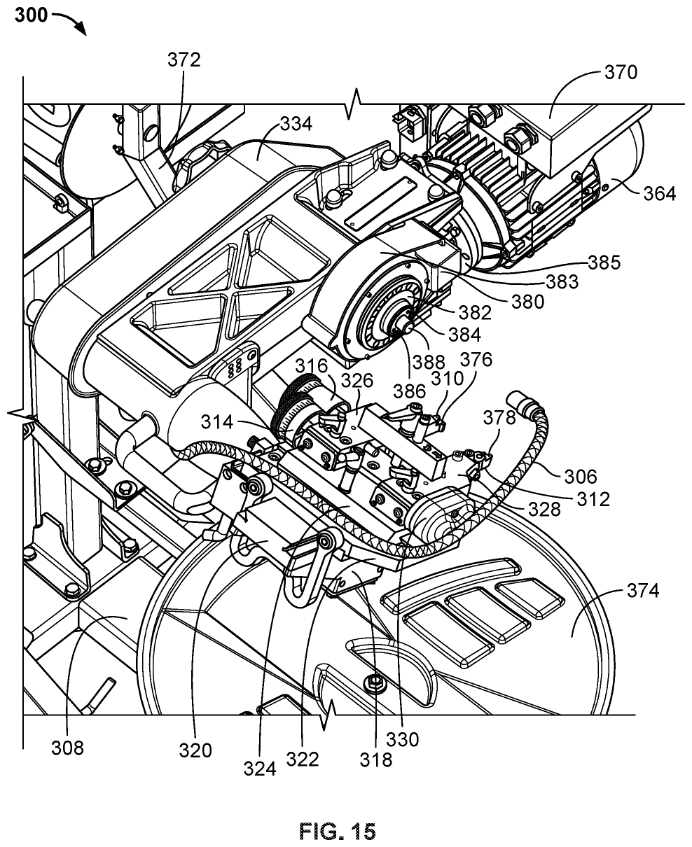

Next, FIG. 9 and FIG. 10 are isometric views of an on-vehicle disk brake lathe system 300 in accordance with example implementations. FIG. 11 and FIG. 12 are side views of the on-vehicle disk brake lathe system 300 shown in FIG. 9 and FIG. 10. FIG. 13 is a top view of the on-vehicle disk brake lathe system 300 shown in FIG. 9 to FIG. 12. FIG. 14 and FIG. 15 are close up isometric views of the on-vehicle disk brake lathe system 300 shown in FIG. 9 to FIG. 13. The on-vehicle disk brake lathe system 300 is attachable to a vehicle, such as the vehicle 10, in order to machine a brake disk, such as the brake disk 28, while the brake disk remains attached to a wheel hub, such as the wheel hub 30, and rotates about a wheel hub axis.

As shown in one or more of FIG. 9 to FIG. 15, the on-vehicle disk brake lathe system 300 includes a cutting mechanism 302, a brake disk drive unit 304, and a capture device 306. The cutting mechanism 302, the brake disk drive unit 304, and the capture device 306 are supported directly or indirectly on a trolley 308. The on-vehicle disk brake lathe system 300 includes a lathe body 334, and a lathe mounting bar 372 for supporting the brake disk drive unit 304. In at least some implementations, at least a portion of a bus 390 connecting the capture device 306 and the display 366 is routed through the lathe mounting bar 372. The on-vehicle disk brake lathe system 300 includes a shaving catcher 374 configured to catch shavings removed from a brake disk during machining of the brake disk. In at least some implementations, the cutting mechanism 302 and the brake disk drive unit 304 are rigidly attached to each other. In at least some of those or other implementations, the brake disk drive unit 304 is attached to the trolley 308.

The on-vehicle disk brake lathe system 300 also includes a display 366, a computer box 368, and a power box 370. The display 366 is configured to display an image, such as an image captured by the captured device 306. The computer box 368 can include a processor, a memory, and a bus, such as the processor 170, the memory 172, and the bus 182 shown in FIG. 6. The computer box 368 includes a connector 377, 379. The connector 377, 379 is configured to connect to a harness. The harness can include a wire to carry electrical power and/or a wire to carry a data signal. An image captured by the capture device 306 can be stored in the memory 172.

The capture device 306 can be arranged like the capture device 200. Accordingly, the capture device 306 can be flexible so that the capture device 306 can be repositioned. Repositioning of the captured device 306 can allow the capture device 306 to be functional to capture an image of the in-board friction face of a brake disk and/or the cutting mechanism 302 and/or an image of the out-board friction face of a brake disk and/or the cutting mechanism 302.

The power box 370 can include components for receiving electrical power from an electrical outlet, switching, and outputting electrical power to other components of the on-vehicle disk brake lathe system 300. As an example, the power box 370 can include a power switch 358 to switch electrical power to the other components of the on-vehicle disk brake lathe system 300 on or off. The power box 370 includes a connector 371, 373, 375. The connector 371, 373, 375 is configured to connect to a harness. The harness can include a wire to carry electrical power and/or a wire to carry a data signal and can connect to the connector 377, 379.

The cutting mechanism 302 includes a cutting tool 310, 312 (shown in FIG. 13), an adjustment dial 314 for adjusting the cutting tool 310, an adjustment dial 316 for adjusting the cutting tool 312, a lateral tool holder plate 324, a cutting tool base top lock 326, 328, and a gear cap 330.

The cutting tool 310, 312 includes a cutting tip 376, 378, respectively, (shown in FIG. 13). A cutting tip has a cutting tip edge configured to contact a friction face of a brake disk and to shave material from the friction face of the brake disk. The cutting tool 310, 312 can be configured such that the cutting tip 376, 378, respectively, are replaceable. Replacement of the cutting tip 376, 378 could occur if the cutting tip is chipped or for some other reason. In at least some implementations, the cutting tip 376, 378 has multiple cutting points such that the cutting tip 376, 378 can be rotated to use a different cutting point before being replaced with a new cutting tip.

The cutting mechanism 302 includes a feed mechanism 390. The feed mechanism 390 includes a gear box 318, a gear box slide plate 320, a slide plate 322, a feed yoke 332, a feed engagement knob 362, a feed nut 392, and a feed screw 394. The feed screw 394 is fixed to the feed yoke 332. Further details of the feed mechanism 390 are shown in FIG. 16. Use of the feed engagement knob 362 can engage automatic feed of the cutting tool 310, 312 along respective feed paths that permit the cutting tip 376, 378 to contact a friction face of the brake disk.

The brake disk drive unit 304 includes a draw bar knob 360, a motor 364, a gear box 380, a run-out adjustment flange 382, a flange guard 383, a guide pin slot 384, 386 within the run-out adjustment flange 382, and an output shaft 388. A motor connection 385 is driven by the motor 364. The motor connection 385 includes the gear box 380 including and gears within the gear box 380 configured to drive a gear box output shaft 414 (shown in FIG. 16) and components coupled directly or indirectly to the gear box output shaft 414. The guide pin slot 384, 386 is configured for receiving a guide pin of a wheel hub adaptor, such as a wheel hub adaptor shown in FIG. 26 and attached to a wheel hub. In at least some implementations, the trolley 308 can be manipulated to raise or lower the run-out adjustment flange 382 and/or the run-out adjustment flange 382 can be rotated such that the guide pin slot 384, 386 is aligned with a guide pin on the wheel hub adaptor attached to wheel hub. Rotation of the draw bar knob 360 can cause the output shaft 388 to rotate into the wheel hub adaptor and to be attached to the wheel hub adaptor.

FIG. 16 is an exploded view diagram of various aspects of the on-vehicle disk brake lathe system 300 in accordance with at least some implementations. As discussed above, the on-vehicle disk brake lathe system 300 includes the brake disk drive unit 304, the lathe body 334, the draw bar knob 360, the feed engagement knob 362, the motor 364, the computer box 368, a power box 370, and the feed mechanism 390. The motor 364 can be configured with a heat shield 400.

The motor 364 is connected to the gear box 380 including a gear box output shaft 414. The gear box output shaft 414 is connected to a pulley 416 that couples to a pulley 418 using a belt 420. The pulley 418 rides on a bushing 422 disposed on an output shaft 424. The run-out adjustment flange 382 is disposed on the output shaft 424. A wheel hub adaptor (e.g., a wheel hub adaptor shown in FIG. 26) is removably attachable to the run-out adjustment flange 382. The flange guard 383 covers at least a portion of the run-out adjustment flange 382. Also mounted on the output shaft 424 is a pulley 430. The pulley 430 couples to a pulley 432 on an idler shaft 436 using a belt 434. An idler tension cam 438 can be used with a belt 442 and a pulley 440 to couple the idler shaft 436 to a drive shaft 410.

The feed engagement knob 362 is connected to and/or proximate to a first end of a drive shaft 410. A gear pinion 407 is connected to a second end of the drive shaft 410. At least a portion of the drive shaft 410 is disposed within a lathe arm 412. The drive shaft 410 turns the gear pinion 407 when the feed engagement knob 362 is engaged for transfer of power from the brake disk drive unit 304 using at least the pulley 416, 430, 432, 440 and the belt 420, 434, 442.

The feed mechanism 390 can include a switch 405, such as a micro-switch, to control operation of the feed mechanism 390. The on-vehicle disk brake lathe system 300 includes a harness 402. The harness 402 can include a wire to carry electrical power and/or a wire to carry a data signal. As an example, one or more wires in the harness 402 can operatively connect to the capture device 306, the switch 405, a sensor 409, and/or a light emitting diode (LED) lamp 411 at one end of the one or more wires and at the display 366, the computer box 368, and/or the power box 370 at a second end of the one or more wires. As an example, the sensor 409 can include a vibration sensor. In at least some implementations, the sensor 409 includes an accelerometer. Additionally or alternatively, in at least some implementations, the sensor 409 can be located on the on-vehicle disk brake lathe system 300 at a location other than a location shown in FIG. 16. As an example, in some implementations, the sensor 409 can be located on or within the computer box 368.

FIG. 17 is an exploded view diagram of the cutting mechanism 302 in accordance with at least some implementations. As discussed above, the cutting mechanism 302 includes the cutting tool 310, 312, the adjustment dial 314, 316, the lateral tool holder plate 324, the cutting tool base top lock 326, 328, the gear cap 330, and the cutting tip 376, 378. As further shown in FIG. 17, the cutting mechanism 302 includes a tool plate rail top lock 461, fasteners 462 to retain the tool plate rail top lock 461 to the lateral tool holder plate 324, and a tension cam 463.

The cutting mechanism 302 also includes an outboard support 464, 465 for the adjustment dial 314, 316, respectively. The outboard support 464, 465 are connected to an inboard dial shaft 466 and an idler shaft 467, respectively. The inboard dial shaft 466 is connected to an outboard dial shaft 468. An inboard support 469 supports the outboard dial shaft 468, the idler shaft 467, and spur gears 470, 471. A nut 472, 473 can be used to fixedly attach the spur gears 470, 471 to the outboard dial shaft 468, the idler shaft 467, respectively. A fastener 482 can fixedly attach the gear cap 330 to the inboard support 469.

Attached to the cutting tool 310 and the cutting tool base top lock 326 are a front arm way 474, a rear arm way 475, and a tool arm back plate 476. Similarly, attached to the cutting tool 312 and the cutting tool base top lock 328 are a front arm way 477, a rear arm way 478, and a tool arm back plate 479. Furthermore, an adjustment lever 480, 481 provides for adjustment of the cutting mechanism 302.

FIG. 18 is an exploded view diagram of aspects of the feed mechanism 408 in accordance with at least some implementations. The feed mechanism 408 includes a gear box 800, a slide plate 802, a shutoff cam rail 804, and the feed yoke 332. A gear 806, such as a bevel gear, can be fixedly positioned on a feed nut 808 using a set screw 810. The gear 806 is driven by another gear, such as the gear pinion 407.

The gear box 800 can include a cover 812 attachable using a fastener 814. The feed nut 808 can be supported by a bearing 816, such as a ball bearing. The bearing 816 can be retained on the feed nut 808 using a clip 818. The feed yoke 332 is connected (e.g., pinned) to a first end of a feed screw 820 so that the feed screw 820 doesn't turn with respect to the feed yoke 332. A second end of the feed screw 820 is positioned within the feed nut 808. The gear box 800 includes a gear box slide 822. In at least some implementations, the gear box slide 822 has a dovetail shape or a rectangular shape. The gear box slide 822 is configured to slide within the slide plate 802. The slide plate 802 is configured to slide upon the gear box slide 822. A fastener 824 can fixedly attach the feed yoke 332 to the slide plate 802.

Turning of the gear 806 by the gear pinion 407 causes the feed nut 808 to turn and to move the feed screw 820, the feed yoke 332, and the slide plate 802 axially with respect to a longitudinal axis of the feed screw 820.

C. Example Implementation of On-Vehicle Disk Brake Lathe System

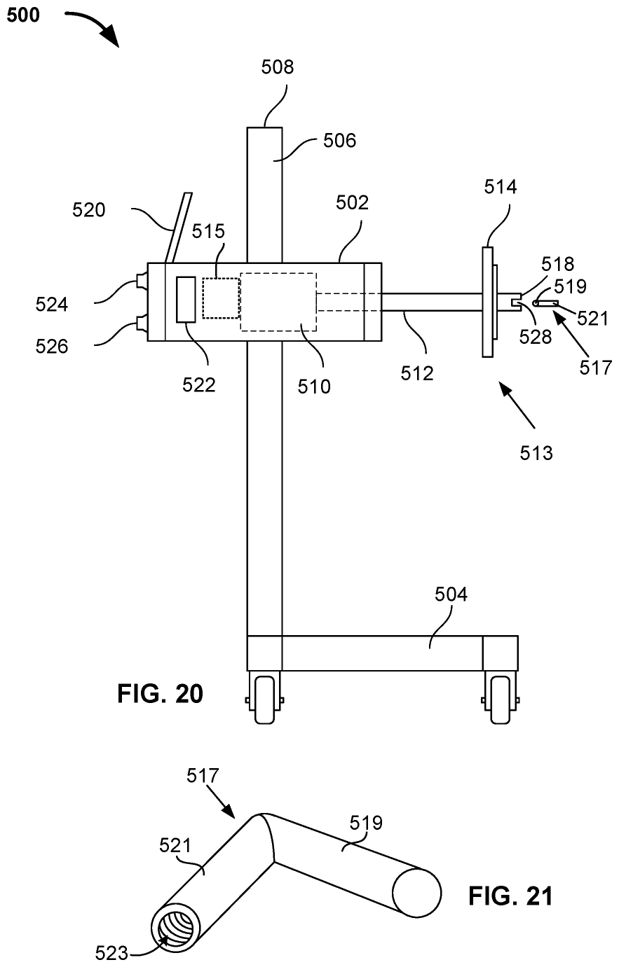

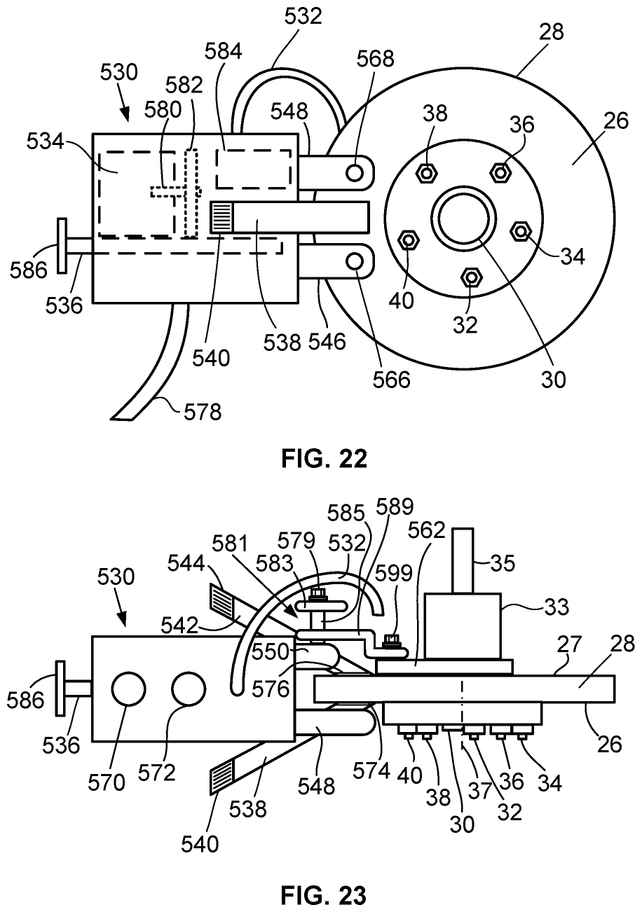

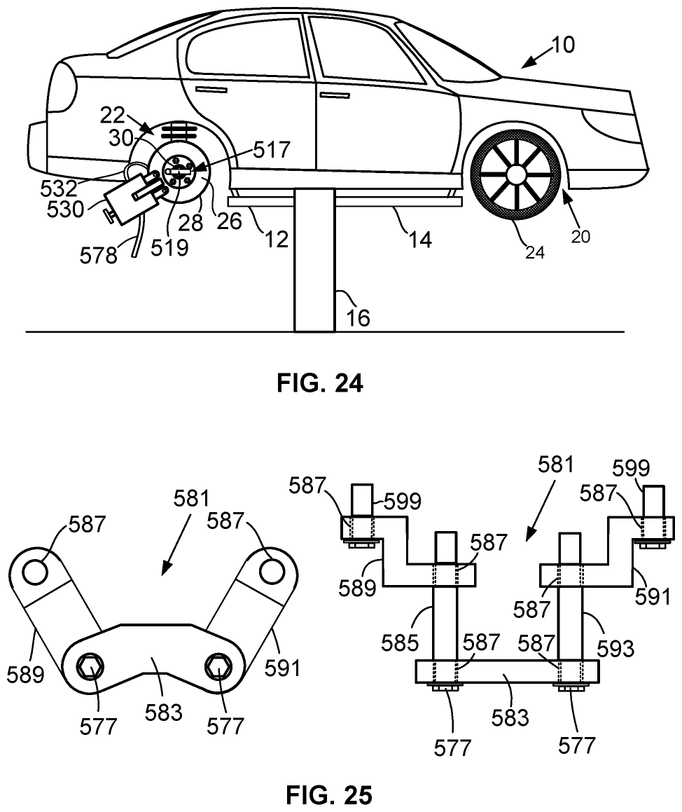

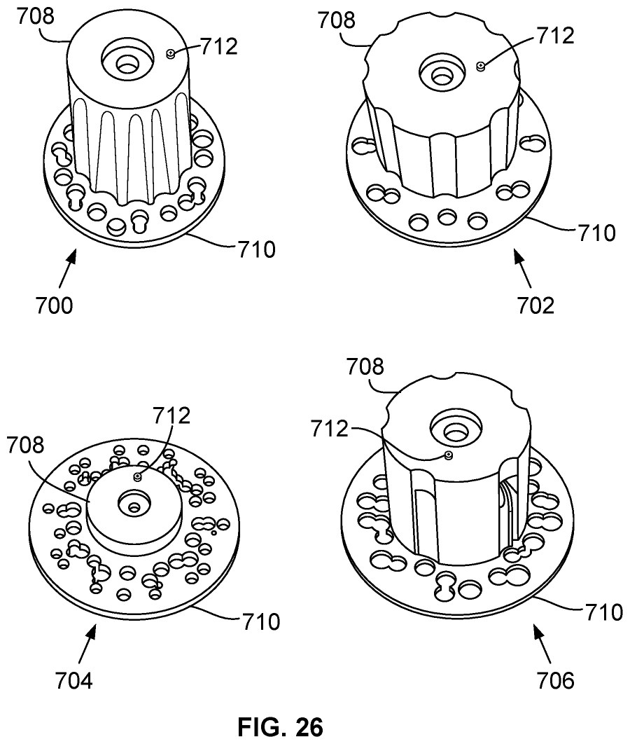

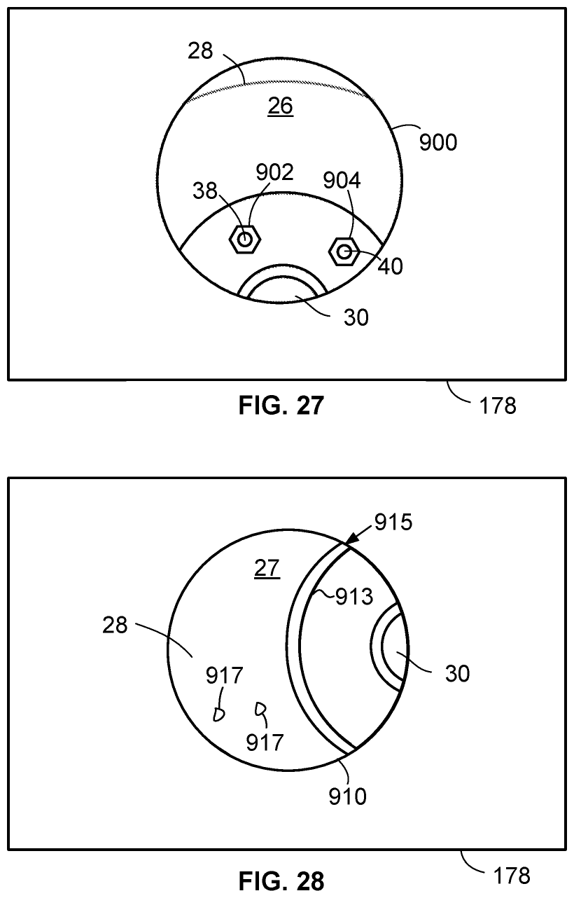

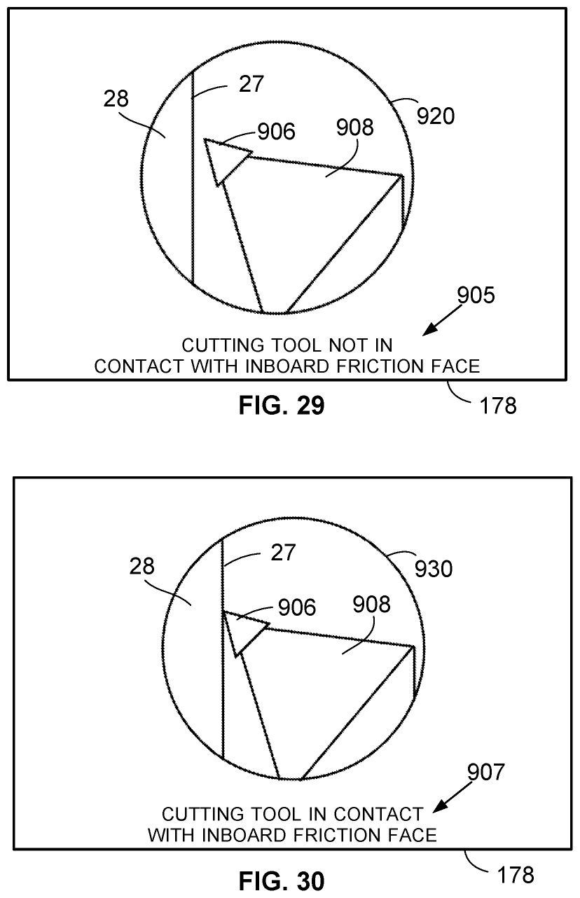

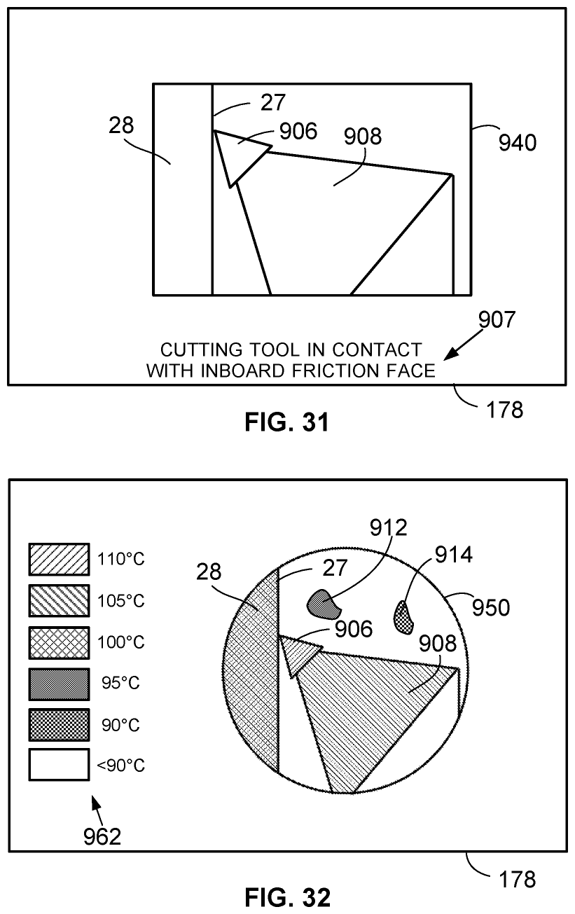

Next, FIG. 19 is an isometric view and FIG. 20 is a side view of a portion of an on-vehicle disk brake lathe system 500 in accordance with example implementations. This portion includes a brake disk drive unit 502. FIG. 22 and FIG. 23 show a side view and a top view of another portion of the on-vehicle disk brake lathe system 500. This other portion includes a cutting mechanism 530 and a capture device 532.

The on-vehicle disk brake lathe system 500 is removably attachable to a vehicle in order to machine a brake disk while the brake disk remains attached to a wheel hub and rotates about a wheel hub axis. For example, the on-vehicle disk brake lathe system 500 can attach to the wheel hub 30 of the vehicle 10 in order to machine the brake disk 28.

The brake disk drive unit 502 is supported on a trolley 504. The trolley 504 includes a vertical post 506 having a post top 508. The brake disk drive unit 502 can be raised and lowered along the vertical post 506 with respect to the post top 508 and with respect to aspects of the vehicle 10, such as the brake disk 28, the wheel hub 30, and the wheel hub axis 37 (shown in FIG. 24). The brake disk drive unit 502 includes a motor 510, a motor shaft 512, a wheel hub adaptor holder 514, a display 520, a harness connector 522, and a switch, such as a switch 524, 526. The harness connector 522 is configured to connect to a harness 578 (shown in FIG. 23). The brake disk drive unit 502 includes a motor connection 513 configured to be driven by the motor 510. In at least some implementations, the motor connection 513 includes the motor shaft 512 and/or the wheel hub adaptor holder 514.

The wheel hub adaptor holder 514 is configured for attaching to a wheel hub adaptor. The wheel hub adaptor is removably attachable to a wheel hub, such as the wheel hub 30. The wheel hub adaptor can, for example, be based on a size, quantity, and spacing of lugs on a wheel hub to which the wheel hub adaptor is configured to be attached. In at least some implementations, the wheel hub adaptor holder 514 includes a guide pin slot 515, 516. A guide pin of a wheel hub adaptor, such as a guide pin 712 shown in FIG. 26, can be positioned within the guide pin slot 515, 516.

In at least some implementations, the wheel hub adaptor holder 514 includes a yoke 518 with a yoke slot 528. In accordance with these implementations, a wheel hub adaptor can be positioned within the yoke slot 528. As an example, a wheel hub adaptor 517 (shown in FIG. 20 and FIG. 21) includes a wheel hub adaptor bar 519 configured to be positioned within the yoke slot 528 and a wheel hub adaptor bar 521 configured to be fastened to a wheel lug, such as a wheel lug 38. In at least some implementations, the wheel hub adaptor bar 521 includes internal threads 523 for fastening the wheel hub adaptor 517 to a wheel lug.

The display 520 can be configured like the display 178. Accordingly, the display 520 can display data captured by the capture device 532. As an example, the display 520 can display an image, such as an image 900, 910, 920, 930, 940, 950, shown in FIG. 27 to FIG. 32.

The switch 524 can include one or more power switches and the switch 526 can include one or more control switches. As an example, the switch 524 can include a switch to turn electrical power to other portions of the on-vehicle disk brake lathe system 500 on or off. For instance, the switch 524 can be used to turn electrical power to the cutting mechanism 530 and the capture device 532 on or off. As another example, the switch 526 can include a switch to change a speed or direction of a motor, such as a speed or direction of the motor 510 or a motor 534 within the cutting mechanism 530. Other examples of the switch 524, 526 are also possible.

Turning to FIG. 22 and FIG. 23, these figures show a cutting mechanism 530 and a capture device 532. The cutting mechanism 530 is attached to a caliper bracket 562 of the vehicle 10. FIG. 24 shows that the vehicle 10 is positioned on the single-post vehicle lift 16. One or more of the single-post vehicle lift 16 and the brake disk drive unit 502 can be raised or lowered so that the wheel hub adaptor holder 514 and the wheel hub axis 37 of the wheel hub 30 are at positions that allow a wheel hub adaptor attached to the wheel hub adaptor holder 514 to be attached to the wheel hub 30. The wheel hub 30 is connected to a joint 33, such as a continuous-varying joint, and an axle shaft 35.

The cutting mechanism 530 includes a motor 534 and a feed mechanism 536 operatively connected to the motor 510. The cutting mechanism 530 also includes a cutting tool 538 and a cutting tool adjuster 540 for moving the cutting tool 538 into or out of contact with the brake disk 28. The cutting mechanism 530 also includes a cutting tool 542 and a cutting tool adjuster 544 for moving the cutting tool 542 into or out of contact with the brake disk 28. The cutting tool 538 includes a cutting tip 574 and the cutting tool 542 includes a cutting tip 576.

The cutting mechanism 530 can also include a processor 584 to control one or more components and/or functions of the cutting mechanism 530. The processor 584 can be arranged like and/or include the processor 170. As an example, the processor 584 can control the capture device 532, the motor 534, and/or the feed mechanism 536. Controlling the feed mechanism 536 using the processor 584 allows for automatic movement of the feed mechanism 536. The cutting mechanism 530 includes a handle 586 to allow for manual movement of the feed mechanism 536. A motor connection can include a motor shaft 580 and a drive gear 582.

The cutting mechanism 530 includes a mounting flange 546, 548, 550 and a mounting flange similar to the mounting flange 550 opposite the mounting flange 546 and below the mounting flange 550 for attachment of the cutting mechanism 530 to the caliper bracket 562. The mounting flange 546 includes an attachment hole 566. The mounting flange 548 includes an attachment hole 568. Similarly, the mounting flange 550 and the other mounting flange can include attachment holes. The attachment holes of the mounting flanges can be threaded.

A caliper bracket mounting adaptor 581 is used to attach the cutting mechanism 530 to the vehicle 10. Details regarding the caliper bracket mounting adaptor 581 are shown in FIG. 25.

The cutting mechanism 530 includes one or more controls of an input interface, such as a switch 570 and a switch 572, for inputting a user input to control the cutting mechanism 530. As an example, use of the switch 570 can change an operating state of the cutting mechanism from on to off or from off to on. As another example, use of the switch 572 can change a speed of the feed mechanism 536.

The harness 578 can include a wire harness with one or more wires. In at least some implementations, the harness 578 includes a wire configured to provide electrical power from the brake disk drive unit 502 to the cutting mechanism 530. In at least some of those implementations or in some other implementations, the harness 578 includes a wire configured to provide the image from the capture device 532 to the display 520. In at least some of those implementations or in some other implementations, the harness 578 includes a wire for carrying a control signal configured to control a component of the on-vehicle disk brake lathe system 500. As an example, the component controlled based on the control signal can include the motor 510, the motor 534, the feed mechanism 536, the cutting tool 538, and/or the cutting tool 542. In at least some implementations, the harness 578 can include a bus for operatively connecting the processor 584 to the processor 511. In at least some implementations, the control signal can include a control signal indicative of a speed of the motor 534, a direction of the motor 534, a speed of the feed mechanism 536, and/or a direction of the feed mechanism.

FIG. 24 shows the vehicle 10 on the single-post vehicle lift 16 with the cutting mechanism 530 attached to the vehicle 10 (e.g., attached to the caliper bracket 562 shown in FIG. 23). The capture device 532 is positioned to be able to capture an image of at least a portion of the brake disk 28 and/or at least a portion of the cutting mechanism 530. As an example, the portion of the brake disk 28 shown in the captured image can include at least a portion of the in-board disk surface of the brake disk 28. The capture device 532 can be configured like the capture device 56 and/or the capture device 200. Accordingly, the capture device 532 can include an image sensor and a light source. The light source can illuminate the brake disk 28 and/or the cutting mechanism 530 within the wheel well 22. For example, the light source can output light onto at least a portion of the first disk surface 26 of the brake disk 28, at least a portion of the second disk surface 27 of the brake disk 28, at least a portion of the cutting tool 538, and/or a least a portion of the cutting tool 542. The capture device 532 can include a borescope.

FIG. 25 shows further details of the caliper bracket mounting adaptor 581. The caliper bracket mounting adaptor 581 includes a bracket 583, 589, 591, and a sleeve 585, 593. The bracket 583, 589, 591 includes a through-hole 587 at various positions in the bracket 583, 589, 591. The sleeve 585 provides a space between the bracket 583 and the bracket 589. The sleeve 593 provides a space between the bracket 583 and the bracket 591. A bolt 577, 579 attaches the caliper bracket mounting adaptor 581 to the cutting mechanism 530. A bolt 599 attaches the caliper bracket mounting adaptor 581 to the caliper bracket 562.

FIG. 26 shows a wheel hub adaptor 700, 702, 704, 706. The wheel hub adaptor 700, 702, 704, 706 includes a brake disk drive unit side 708 and a brake disk side 710. The wheel hub adaptor 700, 702, 704, 706 includes a guide pin 712 on the brake disk drive unit side 708 for placement of the guide pin slot 515, 516. The wheel hub adaptor 700, 702, 704, 706 includes holes or slots on the brake disk side 710 through which lugs on a wheel hub, such as the wheel hub 30, can be disposed. Lug nuts can be threaded onto the wheel lugs to keep the wheel hub adaptor 700, 702, 704, 706 attached to the wheel hub during use of the on-vehicle disk brake lathe system 300, 500. In alternative implementations, the wheel hub adaptor holder 514 can include one or more guide pins and a corresponding wheel hub adaptor can include one or more guide pin slots for accepting the one or more guide pins.

### III. Example Images

Next, FIG. 27 shows an image 900 displayed on the display 178. As an example, the image 900 can be a visible light image. The image 900 includes a portion of the brake disk 28. In particular, the image 900 includes a portion of the first disk surface 26 of the brake disk 28 and a portion of a wheel hub 30 including a wheel lug 38, 40. The image 900 also includes a lug nut 902, 904 holding the brake disk 28 on the wheel hub 30. The lug nut 902, 904 can be used to attach a wheel hub adaptor to the wheel hub 30. The wheel hub adaptor may or may not be connected to the brake disk drive unit 54 during attachment of the wheel hub adaptor to the wheel hub 30.

Next, FIG. 28 shows an image 910 displayed on the display 178. As an example, the image 910 can be a visible light image. The image 910 includes a portion of the brake disk 28. In particular, the image 910 includes a portion of the second disk surface 27 of the brake disk 28 and a portion of the wheel hub 30. The light source 218 can generate light to reflect off of the brake disk 28 so that more light is detected by the image sensor 214 of the capture device. In FIG. 28, the second disk surface 27 is shown to have a disk surface edge 913, a rust ridge 915 that extends away from the disk surface edge 913, and a pit 917. A capture device of the on-vehicle disk brake lathe system can output an image, such as the image 910, so that a display can show the image and a condition of the brake disk 28. A person can view an image output on the display 178 without having to place their head within a wheel well of the vehicle 10.

Next, FIG. 29 shows an image 920 displayed on the display 178. As an example, the image 920 can be a visible light image. The image 920 includes a portion of the brake disk 28 and a cutting tool 908 having a cutting tip 906. The image 920 shows that the cutting tip 906 is not contacting the second disk surface 27 of the brake disk 28. The processor 170 can output a notification 905 on the display 178, such as a notification that indicates the cutting tip 906 is not in contact with the brake disk 28 or the second disk surface 27. The image 920 can show a condition of the cutting tip 906 as the on-vehicle disk brake lathe system is machining the brake disk 28. This is helpful to a user of the on-vehicle disk brake lathe system in case the condition of the cutting tip 906 changes significantly during the machining, such as changing to the cutting tip contacting a rust ridge or a portion of the second disk surface after passing over a pit 917.

In at least some implementations, the processor 170 can execute program instructions to determine whether a cutting tool, such as the cutting tool 908, is actively cutting a brake disk surface, such as the second disk surface 27, based on time-averaged segments of signals from a vibration sensor mounted on the on-vehicle disk brake lathe system 50. Details of making such a determination are described in U.S. Pat. No. 8,180,480, which is incorporated herein by reference. One or more vibration sensors configured to provide signals to the processor 170 can be disposed at various positions of the on-vehicle disk brake lathe systems described herein. In those or in other implementations, the processor 170 can execute program instructions to determine whether a cutting tool is actively cutting a brake disk surface by comparing an image captured by the capture device 56 with one or more images, such an image in which a cutting tool is contacting a brake disk surface and/or an image in which a cutting tool is not contacting a brake disk surface.

Next, FIG. 30 shows an image 930 displayed on the display 178. As an example, the image 930 can be a visible light image. The image 930 includes a portion of a brake disk 28 and the cutting tool 908 having the cutting tip 906. The image 930 shows that the cutting tip 906 is contacting the second disk surface 27 of the brake disk 28. The processor 170 can output a notification 907 on the display 178, such as a notification that indicates the cutting tip 906 is in contact with the brake disk 28 or the second disk surface 27.

Next, FIG. 31 shows an image 940 displayed on the display 178. As an example, the image 940 can be a visible light image. The image 940 includes a portion of the brake disk 28 and the cutting tool 908 having the cutting tip 906. The image 940 shows that the cutting tip 906 is contacting the second disk surface 27 of the brake disk 28. In comparison to FIG. 27 to FIG. 30 that show that a capture device, such as the capture device 56, can capture an image in a circular format, FIG. 31 shows that the capture device can capture an image in a rectangular format. The processor 170 can output a notification 907 on the display 178, such as a notification that indicates the cutting tip 906 is in contact with the brake disk 28 or the second disk surface 27.

Next, FIG. 32 shows an image 950 displayed on the display 178 along with temperature-to-color map 962. As an example, the image 950 can be a thermal image. The image 950 includes a portion of the brake disk 28 and the cutting tool 908 having the cutting tip 906. The image 950 shows that the cutting tip 906 is contacting the second disk surface 27 of the brake disk 28 and a shaving 912, 914 removed during machining of the brake disk 28.

### IV. Example Operation

After raising and supporting the vehicle 10 above the ground, one or more wheels can be removed from the vehicle. With a wheel removed, the on-vehicle disk brake lathe system 60, 300, 500 can be removably attached to the vehicle 10. As an example, the on-vehicle disk brake lathe system 60, 300, 500 can attach to the wheel hub 30. That attachment can occur using an adaptor, such as the wheel hub adaptor 517, 700, 702, 704, 706. The cutting mechanism 52, 63, 302, 530 is positioned in proximity to the brake disk 28 so that the cutting tools of the on-vehicle disk brake lathe system 50, 60, 300, 500 are in contact or in proximity for being placed in contact with the first disk surface 26 and the second disk surface 27.

For implementations in which a position of the capture device 56, 90, 302, 532 is adjustable, that position of the capture device 56, 90, 302, 532 can be adjusted. With the on-vehicle disk brake lathe system 50, 60, 300, 500 powered to an on state, an output of the capture device 56, 90, 302, 532 can be displayed on the display 92, 178, 366, 520. Adjustment of the position of the capture device 56, 90, 302, 532 can be confirmed by viewing the output of the capture device 56, 90, 302, 532, which can be displayed on the display 92, 178, 366, 520.

After adjusting the position of the capture device 56, 90, 302, 532 is completed (for the implementations in which the position of the capture device is adjustable) or confirming the position of the capture device 56, 90, 302, 532 is at a desired position (e.g., a position based on a prior adjustment of the capture device 56, 90, 302, 532 or the capture device 56, 90, 302, 532 being at a pre-determined, fixed position), the brake disk drive unit 54, 61, 304, 502 and the cutting mechanism 52, 63, 302, 530 can be engaged to begin machining the brake disk 28.

The input interface 174 can be used to select a particular GUI to be displayed. The selected GUI can show the output of the capture device 56, 90, 302, 532. The input interface 174 can be used to select which image sensor(s) are to be used to output representations of radiation received by the image sensor(s). The input interface 174 can be used to cause the processor 170 to cause an image captured by the capture device 56, 90, 302, 532 to be stored in the memory 172.

### V. Example Vehicle

A vehicle is a mobile machine that can be used to transport a person, people, and/or cargo. A vehicle can be driven and/or otherwise guided along a path (e.g., a paved road or otherwise) on land, in water, in the air, and/or outer space. A vehicle can be wheeled, tracked, railed, and/or skied. A vehicle can include an automobile, a motorcycle (e.g., a two or three wheel motorcycle), an all-terrain vehicle (ATV) defined by ANSI/SVIA-1-2007, a light-duty truck, a medium-duty truck, a heavy-duty truck, an on-highway truck, a semi-tractor, and/or a farm machine. A vehicle can include and/or use any appropriate voltage and/or current source, such as a battery, an alternator, a fuel cell, and the like, providing any appropriate current and/or voltage, such as about 12 volts, about 42 volts, and the like. A vehicle can, but need not necessarily, include and/or use any system and/or engine to provide its mobility. Those systems and/or engines can include vehicle components that use fossil fuels, such as gasoline, diesel, natural gas, propane, and the like, electricity, such as that generated by a battery, magneto, fuel cell, solar cell and the like, wind and hybrids and/or combinations thereof. A vehicle can, but need not necessarily, include an electronic control unit (ECU), an OBDC, and a vehicle network that connects the OBDC to the ECU. A vehicle can be configured to operate as an autonomous vehicle.

Some vehicles and types of vehicles can be identified by characteristics of the vehicle such as characteristics indicative of when the vehicle was built (e.g., a vehicle year), who built the vehicle (e.g., a vehicle make), marketing names associated with vehicle (e.g., a vehicle model name, or more simply “model”), and features of the vehicle (e.g., an engine type). This description uses an abbreviation YMME and/or Y where each letter in the order shown represents a model year, vehicle make, vehicle model name, and engine type, respectively. This description uses an abbreviation YMM and/or Y/M/M, where each letter in the order shown represents a model year, vehicle make, and vehicle model name, respectively. This description uses an abbreviation YM and/or Y/M, where each letter in the order shown represents a model year and vehicle make, respectively. An example Y/M/M/E is 2014/Toyota/Camry/4Cyl, in which “2014” represents the model year the vehicle was built, “Toyota” represents the name of the vehicle manufacturer Toyota Motor Corporation, Aichi Japan, “Camry” represents a vehicle model built by that manufacturer, and “4Cyl” represents a an engine type a four cylinder internal combustion engine) within the vehicle. An example Y/M/M is 2014/Toyota/Camry. A person skilled in the art will understand that other features in addition to or as an alternative to “engine type” can be used to identify a vehicle. These other features can be identified in various manners, such as a regular production option (RPO) code, such as the RPO codes defined by the General Motors Company LLC, Detroit Mich.

Some vehicles, such as automobiles and on-highway trucks, are associated with a unique vehicle identification number (VIN). Some VINs include seventeen alpha-numeric characters. For at least some seventeen character VINs, the last six characters represent a unique serial number associated with a particular type of vehicle represented by the first eleven alpha-numeric characters of those VINs. The first eleven alpha-numeric characters typically represent at least a YMME, a YMM, and/or a YM. In some instances, a vehicle includes a one dimensional bar code and/or a multi-dimensional code indicative of a VIN associated with that vehicle.

A vehicle network can include one or more conductors (e.g., copper wire conductors) and/or can be wireless. As an example, a vehicle network can include one or two conductors for carrying vehicle data messages in accordance with a vehicle data message (VDM) protocol, such as a bi-directional VDM protocol. A bi-directional VDM protocol can include a Society of Automotive Engineers (SAE®) J1850 (pulse width modulated (PWM) or variable pulse width (VPW)) VDM protocol, an SAE® J1939 VDM protocol based on the SAE® J1939_201808 serial control and communications heavy duty vehicle network-top level document, and/or any other core J1939 standard, an ISO® 15764-4 controller area network (CAN) VDM protocol, an ISO® 9141-2 K-Line VDM protocol, an ISO® 14230-4 KWP2000 K-Line VDM protocol, an ISO® 17458 (e.g., parts 1-5) FlexRay VDM protocol, an ISO® 17987 local interconnect network (LIN) VDM protocol, a CAN 2.0 VDM protocol, standardized in part using an ISO® 11898-1:2015 road vehicle—CAN—Part I: data link layer and physical signaling protocol, a CAN FD VDM protocol (i.e., CAN with flexible data (FD) rate VDM protocol), a MOST® Cooperation VDM protocol (such as the MOST Specification Rev. 3.0 E2, or the MOST® Dynamic Specification, Rev. 3.0.2), an Ethernet VDM protocol (e.g., an Ethernet 802.3 protocol using a BROADR-REACH® physical layer transceiver specification for Automotive Applications by Broadcom Inc., San Jose, Calif.), or some other VDM protocol defined for performing communications with or within the vehicle 10.

An OBDC can include an on-board diagnostic (OBD) connector, such as a J1939 connector, an OBD-I connector, or an OBD-II connector. A J1939 connector is a connector that complies with the SAE J1939 standard. As an example, a J1939 connector can include a J1939 type-1 connector with nine connector terminals, such as a J1939 type-1 connector; part number AHD10-9-1939P, supplied by Amphenol Sine Systems, Clinton Township, Mich. As another example, a J1939 connector can include a J1939 type-2 connector, such as a J1939 type-2 connector with nine connector terminals; part number AHD10-9-1939P80, supplied by Amphenol Sine Systems. An OBD-I connector, for example, can include slots for retaining up to twelve connector terminals. As an example, an OBD-I connector can include a connector part number 12101918 available from dealerships selling products manufactured by General Motors, Detroit, Mich. An OBD-II connector can include slots for retaining up to sixteen connector terminals. An OBD-II connector that meets the SAE J1962 specification includes a connector 16M, part number 12110252, available from Aptiv LLC of Dublin, Ireland. Other examples of the OBDC 113 are also possible.

A vehicle manufacturer and/or a supplier of brake disks to the vehicle manufacturer can define specifications for resurfacing the brake disks.

### VI. Conclusion

The arrangements described herein and/or shown in the drawings are for purposes of example and are not intended to be limiting. As such, those skilled in the art will appreciate that other arrangements and elements (e.g., machines, interfaces, functions, orders, and/or groupings of functions) can be used instead, and some elements can be omitted altogether. Furthermore, various functions described and/or shown in the drawings as being performed by one or more elements can be carried out by a processor executing computer-readable program instructions or by a combination of hardware, firmware, and/or software. For purposes of this description, execution of CRPI contained in a computer-readable medium to perform some function can include executing at least a portion of the program instructions of those CRPI.

While various aspects and implementations are described herein, other aspects and implementations will be apparent to those skilled in the art. The various aspects and implementations disclosed herein are for purposes of illustration and are not intended to be limiting, with the true scope being indicated by the claims, along with the full scope of equivalents to which such claims are entitled. It is also to be understood that the terminology used herein is for the purpose of describing example implementations, and is not intended to be limiting.

In this description, the articles “a,” “an,” and “the” are used to introduce elements and/or functions of the example implementations. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” and “one or more of the following” immediately preceding a list of at least two components or functions is to cover each implementation including a listed component or function independently and each implementation including a combination of the listed components or functions. For example, an implementation described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible implementations: (i) an implementation including A, but not B and not C, (ii) an implementation including B, but not A and not C, (iii) an implementation including C, but not A and not B, (iv) an implementation including A and B, but not C, (v) an implementation including A and C, but not B, (v) an implementation including B and C, but not A, and/or (vi) an implementation including A, B, and C. For the implementations including component or function A, the implementations can include one A or multiple A. For the implementations including component or function B, the implementations can include one B or multiple B. For the implementations including component or function C, the implementations can include one C or multiple C. The use of ordinal numbers such as “first,” “second,” “third” and so on is to distinguish respective elements rather than to denote an order of those elements unless the context of using those terms explicitly indicates otherwise. The use of the symbol “$” as prefix to a number indicates the number is a hexadecimal number.

Implementations of the present disclosure may thus relate to one of the enumerated example embodiments (EEEs) listed below.

EEE 1 is an on-vehicle disk brake lathe system attachable to a vehicle in order to machine a brake disk while the brake disk remains attached to a wheel hub and rotates about a wheel hub axis, the brake disk having an in-board friction face and an out-board friction face opposite the in-board friction face, wherein the on-vehicle disk brake lathe system comprises: a cutting mechanism, a brake disk drive unit including a wheel hub adaptor removably connectable to the wheel hub and a motor configured to rotate the wheel hub adaptor and the brake disk when the wheel hub adaptor is connected to the wheel hub; and a capture device, wherein the capture device is configured to be moved to a position at which the capture device can capture an image showing one or more from among: at least a portion of the brake disk or at least a portion of the cutting mechanism.

EEE 2 is an on-vehicle disk brake lathe system according to EEE 1, wherein the cutting mechanism includes a cutting tool having a cutting tip, wherein the cutting tool is configured to be positioned with the cutting tip contacting the in-board friction face, and wherein the image shows one or more from among: at least a portion of the in-board friction face or at least a portion of the cutting tool.

EEE 3 is an on-vehicle disk brake lathe system according to any one of EEE 1 to 2, further comprising: a motor, wherein the motor includes a first motor and a second motor, wherein the brake disk drive unit includes the first motor, and wherein the cutting mechanism includes the second motor.

EEE 4 is an on-vehicle disk brake lathe system according to any one of EEE 1 to 3, wherein the on-vehicle disk brake lathe system further comprises: a caliper bracket adaptor configured to removably attach the cutting mechanism to a caliper bracket of the vehicle.

EEE 5 is an on-vehicle disk brake lathe system according to any one of EEE 1 to 4, further comprising a wire harness.

EEE 6 is an on-vehicle disk brake lathe system according to EEE 5, wherein the wire harness includes a wire configured to provide electrical power from the brake disk drive unit to the cutting mechanism.

EEE 7 is an on-vehicle disk brake lathe system according to any one of EEE 5 to 6, wherein the wire harness includes a wire configured to provide the image from the capture device to a display.

EEE 8 is an on-vehicle disk brake lathe system according to any one of EEE 5 to 7, wherein the wire harness includes a wire configured to provide a control signal to control a component of the on-vehicle disk brake lathe system.

EEE 9 is an on-vehicle disk brake lathe system according to any one of EEE 2 to 8, wherein the brake disk drive unit is rigidly attached to the cutting mechanism.

EEE 10 is an on-vehicle disk brake lathe system according to any one of EEE 2 to 9, wherein the capture device is movable to a position at which the capture device can capture an image of one or more from among: at least a portion of the in-board friction face, at least a portion of the cutting tool, or at least a portion of the out-board friction face.

EEE 11 is an on-vehicle disk brake lathe system according to any one of EEE 2 to 10, wherein the capture device includes a borescope.

EEE 12 is on-vehicle disk brake lathe system according to any one of EEE 2 to 11, wherein the capture device includes a visible light sensor.

EEE 13 is an on-vehicle disk brake lathe system according to any one of EEE 2 to 12, wherein the capture device includes an infrared sensor.

EEE 14 is an on-vehicle disk brake lathe system according to EEE 13, further comprising: one or more processors, and computer-readable memory containing executable instructions. Execution of the executable instructions by the one or more processors causes the on-vehicle disk brake lathe system to perform functions. The functions comprise capturing a first thermal image showing at least a portion of the brake disk before the on-vehicle disk brake lathe system rotates the brake disk. The functions also comprise determining a first temperature value represented by the first thermal image. The functions further comprise capturing a second thermal image showing at least a portion of the brake disk while the on-vehicle disk brake lathe system rotates the brake disk. Additionally, the functions include determining a second temperature value represented by the second thermal image. Furthermore, the functions include determining, based on a comparison of the first temperature value and the second temperature value, whether or not a first cutting tip of the cutting tip is in contact with the in-board friction face or whether or not a second cutting tip of the cutting tip is in contact with the out-board friction face. Furthermore still, the functions include outputting a notification indicative of whether or not the first cutting tip is in contact with the in-board friction face or whether or not the second cutting tip is in contact with the out-board friction face.

EEE 15 is an on-vehicle disk brake lathe system according to EEE 14, wherein the second thermal image further shows one or more metallic chips removed from the brake disk by the cutting tool, and wherein the second temperature value is based at least in part on a temperature value associated with at least some of the one or more metallic chips.

EEE 16 is an on-vehicle disk brake lathe system according to EEE 15, wherein the second thermal image further shows at least a portion of the cutting tool, and wherein the second temperature value is based at least in part on a temperature value associated with at least a portion of the cutting tool.

EEE 17 is an on-vehicle disk brake lathe system according to any one of EEE 2 to 16, wherein the capture device includes a light source configured to output light onto one or more from among: at least a portion of the in-board friction face, at least a portion of a first cutting tool, at least a portion of the out-board friction face, or at least a portion of a second cutting tool.

EEE 18 is an on-vehicle disk brake lathe system according to any one of EEE 2 to 17, wherein at least a portion of the capture device is mounted to a lathe body.

EEE 19 is an on-vehicle disk brake lathe system according to any one of EEE 2 to 18, further comprising: a display, wherein the display is configured to display the image.

EEE 20 is an on-vehicle disk brake lathe system according to any one of EEE 17 to 19, wherein at least a portion of the capture device is positioned within a wheel well of the vehicle when one or more from among the following is contacting the brake disk: the first cutting tool or the second cutting tool.

EEE 21 is an on-vehicle disk brake lathe system according to any one of EEE 2 to 20, further comprising: a trolley, wherein the brake disk drive unit is attached to the trolley.

EEE 22 is an on-vehicle disk brake lathe system according to EEE 21, wherein the cutting mechanism is attached to the brake disk drive unit.

EEE 23 is an on-vehicle disk brake lathe system according to any one of EEE 1 to 22, further comprising: one or more processors; a display; and a computer-readable memory containing executable instructions, wherein execution of the instructions by the one or more processors cause the on-vehicle disk brake lathe system to perform functions comprising outputting the image onto the display.

EEE 24 is an on-vehicle disk brake lathe system according to any one of EEE 1 to 22, further comprising: the one or more processors; a display; and the computer-readable memory containing executable instructions, wherein execution of the instructions by the one or more processors cause the on-vehicle disk brake lathe system to perform functions comprising outputting the image onto the display.

EEE 25 is an on-vehicle disk brake lathe system according to any one of EEE 1 to 22, further comprising: one or more processors; the display; and a computer-readable memory containing executable instructions, wherein execution of the instructions by the one or more processors cause the on-vehicle disk brake lathe system to perform functions comprising outputting the image onto the display.

EEE 26 is an on-vehicle disk brake lathe system according to any one of EEE 23 to 25, wherein the instructions to perform functions comprising outputting the image onto the display are written into the computer-readable memory by the one or more processors after the on-vehicle disk brake lathe system has machined at least one brake disk.

EEE 27 is an on-vehicle disk brake lathe system according to any one of EEE 1 to 26, wherein the capture device is installed onto the on-vehicle disk brake lathe system after the on-vehicle disk brake lathe system has machined at least one brake disk.

EEE 28 is an on-vehicle disk brake lathe system attachable to a vehicle in order to machine a brake disk while the brake disk remains attached to a wheel hub and rotates about a wheel hub axis, the brake disk having an in-board friction face and an out-board friction face opposite the in-board friction face. The on-vehicle disk brake lathe system comprises a motor. The on-vehicle disk brake lathe system also comprises a brake disk drive unit including: a motor connection configured to be driven by the motor; and a wheel hub adaptor operatively connectable to the motor connection and removably connectable to the wheel hub, wherein the motor connection is further configured to rotate the wheel hub adaptor and the brake disk when the wheel hub adaptor is connected to the wheel hub. Furthermore, the on-vehicle disk brake lathe system also comprises a brake disk drive unit including: a cutting mechanism including: a pair of cutting tools including a first cutting tool having a first cutting tip and a second cutting tool having a second cutting tip, a lathe body connected to the pair of cutting tools, wherein the first cutting tool is configured to be positioned with the first cutting tip contacting the in-board friction face and the second cutting tool is configured to be positioned with the second cutting tip contacting the out-board friction face, and a feed mechanism that is configured to direct the first cutting tool across the in-board friction face along a first feed path as the brake disk rotates and to direct the second cutting tool across the out-board friction face along a second feed path as the brake disk rotates, wherein the feed mechanism is operatively connectable to the motor Furthermore still, the on-vehicle disk brake lathe system also comprises a brake disk drive unit including: a capture device, wherein the capture device is configured to be moved to a position at which the capture device can capture an image showing one or more from among: at least a portion of the brake disk or at least a portion of the cutting mechanism.

EEE 29 is an on-vehicle disk brake lathe system according to EEE 28, wherein the motor includes a first motor and a second motor, wherein the brake disk drive unit includes the first motor, wherein the cutting mechanism includes the second motor, and wherein the on-vehicle disk brake lathe system further comprises: a caliper bracket adaptor configured to removably attach the cutting mechanism to a caliper bracket of the vehicle.

EEE 30 is an on-vehicle disk brake lathe system according to any one of EEE 28 to 29, further comprising a wire harness.

EEE 31 is an on-vehicle disk brake lathe system according to EEE 30, wherein the wire harness includes a wire configured to provide electrical power from the brake disk drive unit to the cutting mechanism.

EEE 32 is an on-vehicle disk brake lathe system according to any one of EEE 30 to 31, wherein the wire harness includes a wire configured to provide for transmitting the image to a display.

EEE 33 is an on-vehicle disk brake lathe system according to any one of EEE 30 to 32, wherein the wire harness includes a wire to provide a control signal to control a component of the on-vehicle disk brake lathe system.

EEE 34 is an on-vehicle disk brake lathe system according to any one of EEE 28 to 33, wherein the brake disk drive unit is rigidly attached to the cutting mechanism.

EEE 35 is an on-vehicle disk brake lathe system according to any one of EEE 28 to 34, wherein the lathe body is configured to keep at least a portion of the feed mechanism in a fixed position relative to a body of the vehicle.

EEE 36 is an on-vehicle disk brake lathe system according to any one of EEE 28 to 35, wherein the capture device is movable to a position at which the capture device can capture an image of one or more from among: at least a portion of the in-board friction face, at least a portion of the first cutting tool, at least a portion of the out-board friction face, or at least a portion of the second cutting tool.

EEE 37 is an on-vehicle disk brake lathe system according to any one of EEE 28 to 36, wherein the capture device includes a borescope.

EEE 38 is an on-vehicle disk brake lathe system according to any one of EEE 28 to 37, wherein the capture device includes a visible light sensor.

EEE 39 is an on-vehicle disk brake lathe system according to any one of EEE 28 to 38, wherein the capture device includes an infrared sensor.

EEE 40 is an on-vehicle disk brake lathe system according to EEE 39, further comprising: one or more processors, and computer-readable memory containing executable instructions. Execution of the executable instructions by the one or more processors causes the on-vehicle disk brake lathe system to perform functions. The functions comprise capturing a first thermal image showing at least a portion of the brake disk before the on-vehicle disk brake lathe system rotates the brake disk. The functions also comprise determining a first temperature value represented by the first thermal image. The functions further comprise capturing a second thermal image showing at least a portion of the brake disk while the on-vehicle disk brake lathe system rotates the brake disk. Additionally, the functions include determining a second temperature value represented by the second thermal image. Furthermore, the functions include determining, based on a comparison of the first temperature value and the second temperature value, whether or not the first cutting tip is in contact with the in-board friction face or whether or not the second cutting tip is in contact with the out-board friction face. Furthermore still, the functions include outputting a notification indicative of whether or not the first cutting tip is in contact with the in-board friction face or whether or not the second cutting tip is in contact with the out-board friction face.

EEE 41 is an on-vehicle disk brake lathe system according to EEE 40, wherein the second thermal image further shows one or more metallic chips removed from the brake disk by the first cutting tool or by the second cutting tool, and wherein the second temperature value is based at least in part on a temperature value associated with at least some of the one or more metallic chips.

EEE 42 is an on-vehicle disk brake lathe system according to EEE 40, wherein the second thermal image further shows at least a portion of the first cutting tool or at least a portion of the second cutting tool, and wherein the second temperature value is based at least in part on a temperature value associated with at least a portion of the first cutting tool and at least a portion of the second cutting tool.

EEE 43 is an on-vehicle disk brake lathe system according to any one of EEE 28 to 42, wherein the capture device includes a light source configured to output light onto one or more from among: at least a portion of the in-board friction face, at least a portion of the first cutting tool, at least a portion of the out-board friction face, or at least a portion of the second cutting tool.

EEE 44 is an on-vehicle disk brake lathe system according to any one of EEE 28 to 43, wherein at least a portion of the capture device is mounted to the lathe body.

EEE 45 is an on-vehicle disk brake lathe system according to any one of EEE 28 to 44, further comprising: a display, wherein the display is configured to display the image.

EEE 46 is an on-vehicle disk brake lathe system according to any one of EEE 28 to 45, wherein at least a portion of the capture device is positioned within a wheel well of the vehicle when one or more from among the following is contacting the brake disk: the first cutting tool or the second cutting tool.

EEE 47 is an on-vehicle disk brake lathe system according to any one of EEE 28 to 46, further comprising: a trolley, wherein the brake disk drive unit is attached to the trolley.

EEE 48 is an on-vehicle disk brake lathe system according to EEE 47, wherein the cutting mechanism is attached to the brake disk drive unit.

EEE 49 is an on-vehicle disk brake lathe system according to any one of EEE 28 to 49, further comprising: one or more processors; a display; and a computer-readable memory containing executable instructions, wherein execution of the instructions by the one or more processors cause the on-vehicle disk brake lathe system to perform functions comprising outputting the image onto the display.

EEE 50 is an on-vehicle disk brake lathe system according to any one of EEE 28 to 49, further comprising: the one or more processors; a display; and the computer-readable memory containing executable instructions, wherein execution of the instructions by the one or more processors cause the on-vehicle disk brake lathe system to perform functions comprising outputting the image onto the display.

EEE 51 is an on-vehicle disk brake lathe system according to any one of EEE 28 to 49, further comprising: one or more processors; the display; and a computer-readable memory containing executable instructions, wherein execution of the instructions by the one or more processors cause the on-vehicle disk brake lathe system to perform functions comprising outputting the image onto the display.

EEE 52 is an on-vehicle disk brake lathe system according to any one of EEE 49 to 51, wherein the instructions to perform functions comprising outputting the image onto the display are written into the computer-readable memory by the one or more processors after the on-vehicle disk brake lathe system has machined at least one brake disk.

EEE 53 is an on-vehicle disk brake lathe system according to any one of EEE 28 to 52, wherein the capture device is installed onto the on-vehicle disk brake lathe system after the on-vehicle disk brake lathe system has machined at least one brake disk.

What is claimed is:

1. An on-vehicle disk brake lathe system attachable to a vehicle in order to machine a brake disk while the brake disk remains attached to a wheel hub and rotates about a wheel hub axis, the brake disk having an in-board friction face and an out-board friction face opposite the in-board friction face, wherein the on-vehicle disk brake lathe system comprises:
a cutting mechanism;
a brake disk drive unit including a wheel hub adaptor removably connectable to the wheel hub and a motor configured to rotate the wheel hub adaptor and the brake disk when the wheel hub adaptor is connected to the wheel hub; and
a capture device, wherein the capture device is configured to be moved to a position at which the capture device can capture an image showing one or more from among: at least a portion of the brake disk or at least a portion of the cutting mechanism.

2. An on-vehicle disk brake lathe system according to claim 1,
wherein the cutting mechanism includes a cutting tool having a cutting tip,
wherein the cutting tool is configured to be positioned with the cutting tip contacting the in-board friction face, and
wherein the image shows one or more from among: at least a portion of the in-board friction face or at least a portion of the cutting tool.

3. An on-vehicle disk brake lathe system attachable to a vehicle in order to machine a brake disk while the brake disk remains attached to a wheel hub and rotates about a wheel hub axis, the brake disk having an in-board friction face and an out-board friction face opposite the in-board friction face, wherein the on-vehicle disk brake lathe system comprises:
a motor;
a brake disk drive unit including:
a motor connection configured to be driven by the motor; and
a wheel hub adaptor operatively connectable to the motor connection and removably connectable to the wheel hub, wherein the motor connection is further configured to rotate the wheel hub adaptor and the brake disk when the wheel hub adaptor is connected to the wheel hub;
a cutting mechanism including:
a pair of cutting tools including a first cutting tool having a first cutting tip and a second cutting tool having a second cutting tip,
a lathe body connected to the pair of cutting tools, wherein the first cutting tool is configured to be positioned with the first cutting tip contacting the in-board friction face and the second cutting tool is configured to be positioned with the second cutting tip contacting the out-board friction face, and
a feed mechanism that is configured to direct the first cutting tool across the in-board friction face along a first feed path as the brake disk rotates and to direct the second cutting tool across the out-board friction face along a second feed path as the brake disk rotates, wherein the feed mechanism is operatively connectable to the motor; and
a capture device, wherein the capture device is configured to be moved to a position at which the capture device can capture an image showing one or more from among: at least a portion of the brake disk or at least a portion of the cutting mechanism.

4. An on-vehicle disk brake lathe system according to claim 3,
wherein the motor includes a first motor and a second motor,
wherein the brake disk drive unit includes the first motor,
wherein the cutting mechanism includes the second motor, and
wherein the on-vehicle disk brake lathe system further comprises:
a caliper bracket adaptor configured to removably attach the cutting mechanism to a caliper bracket of the vehicle.

5. An on-vehicle disk brake lathe system according to claim 4, further comprising:
a wire harness, and optionally,
wherein the wire harness includes one or more from among: a wire configured to provide electrical power from the brake disk drive unit to the cutting mechanism, a wire configured to provide the image from the capture device to a display, or a wire to provide a control signal to control a component of the on-vehicle disk brake lathe system.

6. An on-vehicle disk brake lathe system according to claim 3, wherein the brake disk drive unit is rigidly attached to the cutting mechanism.

7. An on-vehicle disk brake lathe system according to claim 3, wherein the lathe body is configured to keep at least a portion of the feed mechanism in a fixed position relative to a body of the vehicle.

8. An on-vehicle disk brake lathe system according to claim 3, wherein the capture device is movable to a position at which the capture device can capture an image of one or more from among: at least a portion of the in-board friction face, at least a portion of the first cutting tool, at least a portion of the out-board friction face, or at least a portion of the second cutting tool.

9. An on-vehicle disk brake lathe system according to claim 3, wherein the capture device includes a borescope.

10. An on-vehicle disk brake lathe system according to claim 3, wherein the capture device includes a visible light sensor.

11. An on-vehicle disk brake lathe system according to claim 3, wherein the capture device includes an infrared sensor.

12. An on-vehicle disk brake lathe system according to claim 11, further comprising:
one or more processors, and
computer-readable memory containing executable instructions, wherein execution of the executable instructions by the one or more processors causes the on-vehicle disk brake lathe system to perform functions comprising:
capturing a first thermal image showing at least a portion of the brake disk before the on-vehicle disk brake lathe system rotates the brake disk;
determining a first temperature value represented by the first thermal image;
capturing a second thermal image showing at least a portion of the brake disk while the on-vehicle disk brake lathe system rotates the brake disk;
determining a second temperature value represented by the second thermal image;
determining, based on a comparison of the first temperature value and the second temperature value, whether or not the first cutting tip is in contact with the in-board friction face or whether or not the second cutting tip is in contact with the out-board friction face; and
outputting a notification indicative of whether or not the first cutting tip is in contact with the in-board friction face or whether or not the second cutting tip is in contact with the out-board friction face.

13. An on-vehicle disk brake lathe system according to claim 12,
wherein the second thermal image further shows one or more metallic chips removed from the brake disk by the first cutting tool or by the second cutting tool, and
wherein the second temperature value is based at least in part on a temperature value associated with at least some of the one or more metallic chips.

14. An on-vehicle disk brake lathe system according to claim 12,
wherein the second thermal image further shows at least a portion of the first cutting tool or at least a portion of the second cutting tool, and
wherein the second temperature value is based at least in part on a temperature value associated with at least a portion of the first cutting tool and at least a portion of the second cutting tool.

15. An on-vehicle disk brake lathe system according to claim 3, wherein the capture device includes a light source configured to output light onto one or more from among: at least a portion of the in-board friction face, at least a portion of the first cutting tool, at least a portion of the out-board friction face, or at least a portion of the second cutting tool.

16. An on-vehicle disk brake lathe system according to claim 3, wherein at least a portion of the capture device is mounted to the lathe body.

17. An on-vehicle disk brake lathe system according to claim 3, further comprising:
a display, wherein the display is configured to display the image.

18. An on-vehicle disk brake lathe system according to claim 3, wherein at least a portion of the capture device is positioned within a wheel well of the vehicle when one or more from among the following is contacting the brake disk: the first cutting tool or the second cutting tool.

19. An on-vehicle disk brake lathe system according to claim 3, further comprising:
a trolley, wherein the brake disk drive unit is attached to the trolley, and optionally,
wherein the cutting mechanism is attached to the brake disk drive unit.

20. An on-vehicle disk brake lathe system according to claim 3, further comprising:
one or more processors;
a display; and
a computer-readable memory containing executable instructions, wherein execution of the instructions by the one or more processors cause the on-vehicle disk brake lathe system to perform functions comprising:
outputting the image onto the display.

21. An on-vehicle disk brake lathe system according to claim 20,
wherein the instructions to perform functions comprising outputting the image onto the display are written into the computer-readable memory by the one or more processor after the on-vehicle disk brake lathe system has machined at least one brake disk, and optionally,
wherein the capture device is installed onto the on-vehicle disk brake lathe system after the on-vehicle disk brake lathe system has machined at least one brake disk.
